(19) United States
(12) Patent Application Publication
(10) Pub. No.: US 2026/0353007 A1
(43) Pub. Date: Nov. 5, 2026

(54) SOUND EMITTING DEVICE AND SOUND EMITTING MODULE

(71) Applicant: GOERTEK INC., Weifang (CN)

(72) Inventors: Xiaodong CAI, Weifang (CN); Linlin ZHANG, Weifang (CN)

(21) Appl. No.: 19/727,786

(22) Filed: Jul. 1, 2026

Related U.S. Application Data
(63) Continuation of application No. PCT/CN2025/105498, filed on Jun. 30, 2025.

(30) Foreign Application Priority Data
Jan. 2, 2025 (CN) 202520005941.8

(51) Int. Cl. H04R 7/18; H04R 1/02; H04R 9/02; H04R 9/06

(52) U.S. Cl. CPC H04R 7/18; H04R 1/025; H04R 9/025; H04R 9/06; H04R 2207/021; H04R 2400/11

(57) ABSTRACT

A sound emitting device includes a housing having a sound output hole, a magnetic circuit system having a magnetic gap, and a vibration system. The vibration system includes a first diaphragm assembly having an inner folded ring, a first vibrating plate, and an outer folded ring connected in sequence. The inner folded ring connects to the magnetic circuit system, and the outer folded ring connects to the housing. A voice coil connects to the first vibrating plate and is suspended in the magnetic gap. A diaphragm and a second diaphragm assembly are sequentially arranged on a side of the first diaphragm assembly facing the voice coil. Outer and inner edges of the diaphragm and the second diaphragm assembly respectively connect to the housing and the first diaphragm assembly, defining an acoustic cavity in communication with the sound output hole.

### CROSS-REFERENCE TO RELATED APPLICATIONS

This application is a continuation application of International Application No. PCT/CN2025/105498, filed on Jun. 30, 2025, which claims priority to Chinese Patent Application No. 202520005941.8, filed on Jan. 2, 2025. All of the aforementioned applications are incorporated herein by reference in their entireties.

### TECHNICAL FIELD

The present application relates to the technical field of electroacoustic energy conversion, and more particularly, to a sound emitting device and a sound emitting module using the sound emitting device.

### BACKGROUND

In recent years, with the rapid development of consumer electronic products, people's requirements for electronic products are constantly increasing, such as portability and comfort. The sound emitting device is an important electroacoustic energy conversion component in consumer electronic products, and it is widely applied as speakers, receivers, earphones, and the like. With the improvement of the performance of electronic products, the improvement of the acoustic performance of related sound emitting devices is also an inevitable trend.

The sound emitting device drives a diaphragm in a vibration system to vibrate through a magnetic circuit system, repeatedly pushing air to emit sound. As the core component of the sound emitting device, the diaphragm directly affects the acoustic performance of the sound emitting device. Among them, the effective vibration area (Sd) of the diaphragm is one of the important factors affecting the acoustic performance of the sound emitting device. The larger the effective vibration area of the diaphragm, the better the acoustic performance of the sound emitting device. However, the effective vibration area of the diaphragm of the sound emitting device in the related art is small, causing the acoustic performance of the sound emitting device to be affected.

### SUMMARY

The main purpose of the present application is to provide a sound emitting device and a sound emitting module, aiming to provide a sound emitting device with an increased effective vibration area. Compared with a conventional speaker, the sound emitting device increases the effective vibration area under the same amplitude condition, improves the performance of the sound emitting device, and realizes the thinning of the product size under the same performance condition.

In order to achieve the above purpose, the present application provides a sound emitting device. The sound emitting device includes: a housing provided with a sound output hole; a magnetic circuit system connected to the housing and provided with a magnetic gap; and a vibration system including a first diaphragm assembly, a second diaphragm assembly, a voice coil, and a diaphragm, the first diaphragm assembly includes an inner folded ring, a first vibrating plate, and an outer folded ring connected in sequence; an inner side of the inner folded ring is connected to the magnetic circuit system; an outer peripheral edge of the outer folded ring is connected to the housing; a first end of the voice coil is connected to the first vibrating plate, and a second end of the voice coil is suspended in the magnetic gap; the diaphragm and the second diaphragm assembly are sequentially provided at a side of the first diaphragm assembly facing the voice coil and are provided at an outer side of the voice coil; an outer edge of the diaphragm and an outer edge of the second diaphragm assembly are connected to the housing; and an inner edge of the diaphragm and an inner edge of the second diaphragm assembly are connected to the first diaphragm assembly, to form an acoustic cavity communicating with the sound output hole between the diaphragm and the second diaphragm assembly.

In an embodiment, the second diaphragm assembly includes a folded ring portion and a second vibrating plate, an outer peripheral edge of the folded ring portion is connected to the housing, the second vibrating plate includes a main body portion connected to an inner edge of the folded ring portion and a first bent portion extending in a bending manner from the main body portion toward the first diaphragm assembly, and the first bent portion is connected to at least one of the first diaphragm assembly and the inner edge of the diaphragm.

In an embodiment, an inclined portion is formed at a connection between the main body portion and the first bent portion, and the inclined portion is provided at an angle with respect to a vibration direction of the vibration system; and/or an outer peripheral edge of the folded ring portion is bent to form a first flange, and the first flange is connected to an outer wall of the housing.

In an embodiment, the magnetic circuit system includes a magnetic yoke, a central magnetic portion provided at the magnetic yoke and a side magnetic portion provided at the magnetic yoke; the side magnetic portion is provided at an outer side of the central magnetic portion, and forms the magnetic gap together with the central magnetic portion; the inner side of the inner folded ring is connected to the central magnetic portion; the side magnetic portion includes a plurality of side magnetic portions, and a clearance space is formed between two adjacent side magnetic portions; the second vibrating plate has a first extending portion extending to the clearance space; the diaphragm has a second extending portion extending to the clearance space, and the second extending portion corresponds to and is connected to the first extending portion; or the voice coil has a first protruding portion extending to the clearance space, the central magnetic portion has a second protruding portion extending to the clearance space, and the first protruding portion is opposite to the second protruding portion.

In an embodiment, the diaphragm is a flexible element; the diaphragm includes an outer connection portion, a deformation portion, and an inner connection portion connected in sequence; an outer peripheral edge of the outer connection portion is connected to the housing; an inner edge of the inner connection portion is connected to at least one of the first diaphragm assembly and the first bent portion; and the deformation portion is in a bent shape.

In an embodiment, an inner edge of the inner connection portion extends along an inner surface of the first diaphragm assembly to form a second flange, and an end of the first bent portion adjacent to the first diaphragm assembly forms a flat section extending along the inner surface of the first diaphragm assembly; and the second flange is sandwiched between the first diaphragm assembly and the flat section; or, the flat section is sandwiched between the second flange and the first diaphragm assembly; or, the second flange is connected to the first diaphragm assembly, and the flat section is connected to the first diaphragm assembly.

In an embodiment, a projection width L1 of the deformation portion along a vibration direction of the vibration system is greater than or equal to a projection width L2 of a deformation section of the folded ring portion, and a ratio of L1 to L2 is 1:1 to 3:1; and/or the deformation portion protrudes in a direction away from the first diaphragm assembly, the deformation section of the folded ring portion protrudes in a direction toward the first diaphragm assembly, and the deformation portion and the deformation section of the folded ring portion are staggered in a direction perpendicular to the vibration system; and/or both the inner folded ring and the outer folded ring protrude in a direction away from the magnetic circuit system; and/or a compliance of the diaphragm is greater than or equal to a compliance of the folded ring portion.

In an embodiment, an effective vibration area Sd1 of the diaphragm is smaller than an effective vibration area Sd2 of the second diaphragm assembly, and a ratio of Sd1 to Sd2 is 1:1.5 to 1:3.

In an embodiment, the first vibrating plate bends and extends toward the voice coil to form a second bent portion, and the second bent portion is connected to the voice coil; or, the first diaphragm assembly further includes a first bracket, a first end of the first bracket is connected to the first vibrating plate, and a second end of the first bracket is connected to the voice coil; and/or the inner edge of the diaphragm is connected to the first vibrating plate, and the inner edge of the second diaphragm assembly is connected to the first vibrating plate; the first vibrating plate is provided with a protruding portion approaching the diaphragm; the inner edge of the diaphragm is connected to the protruding portion, and the inner edge of the second diaphragm assembly is connected to the protruding portion; or, the first diaphragm assembly further includes a second bracket; a first end of the second bracket is connected to the first vibrating plate; a second end of the second bracket is connected to the inner edge of the diaphragm, and the second end of the second bracket is connected to the inner edge of the second diaphragm assembly; and/or an outer peripheral edge of the outer folded ring is bent and extends to form a third flange, and the third flange is connected to an outer wall of the housing.

In an embodiment, a first rear cavity is enclosed between the first diaphragm assembly and the diaphragm; a second rear cavity is enclosed among the first diaphragm assembly, the second diaphragm assembly, the housing, and the magnetic circuit system; the first vibrating plate is provided with a protruding portion approaching the diaphragm; the inner edge of the diaphragm and the inner edge of the second diaphragm assembly are both connected to the protruding portion; and the protruding portion is provided with an airflow channel communicating the first rear cavity with the second rear cavity.

In an embodiment, the airflow channel includes a plurality of airflow channels spaced apart along the protruding portion; and/or the first vibrating plate extends in a bending manner toward the voice coil to form a second bent portion, the second bent portion is connected to the voice coil, and the second bent portion is provided with a notch.

In an embodiment, the vibration system further includes a centring disk; the centring disk includes an outer fixing portion, an inner fixing portion, and a vibrating arm connecting the outer fixing portion and the inner fixing portion; the outer fixing portion is connected to the housing; the second diaphragm assembly includes a folded ring portion and a second vibrating plate connected to the folded ring portion; an outer peripheral edge of the folded ring portion is connected to the housing; an inner edge of the second vibrating plate is connected to at least one of the first diaphragm assembly and the inner edge of the diaphragm; and the inner fixing portion is connected to the second vibrating plate and the voice coil, and the inner fixing portion is electrically connected to a lead wire of the voice coil.

In an embodiment, the inner fixing portion includes a body portion and a third extending portion extending from the body portion toward the voice coil; the body portion is connected to the second vibrating plate; the third extending portion is connected to the voice coil; the third extending portion or the body portion is provided with an inner soldering pad electrically connected to the lead wire of the voice coil; and/or the outer fixing portion is annular, the outer fixing portion has short axis sides and long axis sides connected to each other in an alternating sequence, the vibrating arm leads out from a side of the inner fixing portion corresponding to the short axis side, bends, and then extends along the long axis side, and the vibrating arm is connected to a central region of the long axis side; and/or the centring disk further includes a conductive portion, a first end of the conductive portion is connected to the outer fixing portion, a second end of the conductive portion extends in a direction away from the housing, and the conductive portion is provided with an external soldering pad.

In an embodiment, the magnetic circuit system includes a magnetic yoke, a central magnetic portion provided at the magnetic yoke and a side magnetic portion provided at the magnetic yoke; the side magnetic portion is provided at an outer side of the central magnetic portion, and forms the magnetic gap together with the central magnetic portion; the central magnetic portion includes a first central magnet, a central pole plate, and a second central magnet; the first central magnet, the central pole plate, and the second central magnet are provided in a stack; the first central magnet is connected to the magnetic yoke; an inner side of the inner folded ring is connected to the second central magnet; and the first central magnet and the second central magnet are both magnetized along a vibration direction of the vibration system, and magnetization directions of the first central magnet and the second central magnet are opposite.

In an embodiment, the vibration system further includes a centring disk, the centring disk includes an outer fixing portion, an inner fixing portion, and a vibrating arm connecting the outer fixing portion and the inner fixing portion, the outer fixing portion is connected to the housing, and the inner fixing portion is connected to the voice coil and is electrically connected to a lead wire of the voice coil; and the magnetic yoke is provided with a clearance structure corresponding to the inner fixing portion, and the clearance structure is a recessed groove or a through hole; and/or, the side magnetic portion includes a plurality of side magnetic portions, a clearance space is formed between two adjacent side magnetic portions, the voice coil has a first protruding portion extending to the clearance space, and the first protruding portion is connected to the inner fixing portion; and/or the side magnetic portion includes a side magnet and a side pole plate, and the side magnet and the side pole plate are provided in a stack; the side magnet is connected to the magnetic yoke; the side pole plate is opposite to the central pole plate; and a magnetization direction of the side magnet is opposite to the magnetization direction of the first central magnet.

In an embodiment, the housing includes a first housing and a second housing; the first housing is provided with the sound output hole; the outer peripheral edge of the outer folded ring and the outer peripheral edge of the diaphragm are both connected to the first housing; the magnetic circuit system is connected to the second housing; and the outer peripheral edge of the second diaphragm assembly is sandwiched between the first housing and the second housing.

In an embodiment, the first housing has a side wall and an inner bent portion formed by bending and extending inward from an end of the side wall away from the second housing; the outer peripheral edge of the outer folded ring and the outer peripheral edge of the diaphragm are both connected to the inner bent portion; the outer peripheral edge of the second diaphragm assembly is sandwiched between an end of the side wall away from the inner bent portion and the second housing; and the sound output hole is provided at the side wall or the inner bent portion.

In an embodiment, the inner bent portion includes an upper surface, a lower surface, and an inner side surface; the upper surface and the lower surface face away from each other; the inner side surface connects the upper surface and the lower surface, and is provided at an end of the inner bent portion away from the side wall; and the outer peripheral edge of the outer folded ring is connected to the upper surface, and the outer peripheral edge of the diaphragm is connected to the lower surface; or, the outer peripheral edge of the outer folded ring is connected to the upper surface, and the outer peripheral edge of the diaphragm is sandwiched between the outer peripheral edge of the outer folded ring and the upper surface.

In an embodiment, the first housing is a metal housing, and the second housing is a metal housing; the first housing is provided with a welding portion extending toward the magnetic circuit system; the welding portion is welded to the magnetic circuit system or the second housing; and/or, the magnetic circuit system or the second housing is provided with a welding portion extending toward the first housing; the welding portion is welded to an outer wall of the first housing; and/or, the sound emitting device further includes a metal soldering piece; a first end of the metal soldering piece is welded to the magnetic circuit system or the second housing; a second end of the metal soldering piece is welded to the outer wall of the first housing; and/or the second housing and the magnetic yoke of the magnetic circuit system are an integrally formed structure; and/or the vibration system further includes a centring disk; the centring disk includes an outer fixing portion, an inner fixing portion, and a vibrating arm connecting the outer fixing portion and the inner fixing portion; the outer fixing portion is sandwiched between the second housing and the outer peripheral edge of the second diaphragm assembly; and the inner fixing portion is connected to the voice coil and is electrically connected to a lead wire of the voice coil.

A sound emitting module includes a module housing provided with mounting cavity and a sound output port communicating with the mounting cavity; and the sound emitting device as described above; the sound emitting device is provided at the mounting cavity, a front acoustic cavity is formed between the first diaphragm assembly of the sound emitting device and the module housing, and the front acoustic cavity is communicated with the sound output port; and the acoustic cavity of the sound emitting device is in communication with the sound output port through the front acoustic cavity; or, the module housing is further provided with a sound output channel, and the acoustic cavity of the sound emitting device is in communication with the sound output port through the sound output channel; or, the sound output hole of the sound emitting device faces and is in communication with the sound output port.

The sound emitting device according to the technical solution of the present application accommodates the magnetic circuit system and the vibration system in the housing, and sets the magnetic gap in the magnetic circuit system, and sets the first diaphragm assembly, the second diaphragm assembly, the voice coil, and the diaphragm in the vibration system. Thus, the inner side of the inner folded ring of the first diaphragm assembly is connected to the magnetic circuit system, the outer peripheral edge of the outer folded ring is connected to the housing, the first end of the voice coil is connected to the first diaphragm assembly, and the second end of the voice coil is suspended in the magnetic gap. As a result, current is passed into the voice coil, making the voice coil convert electrical energy into mechanical energy in the magnetic gap formed by the magnetic circuit system, to drive the voice coil to drive the first diaphragm assembly to vibrate, realizing sound emission; at the same time, the diaphragm and the second diaphragm assembly are sequentially provided below the first diaphragm assembly and provided at the outer side of the voice coil, and the first diaphragm assembly is configured as the inner folded ring, the first vibrating plate, and the outer folded ring which are connected in sequence. Thus, the inner side of the inner folded ring is connected to the magnetic circuit system, the outer peripheral edge of the outer folded ring is connected to the housing. As a result, the first end of the voice coil is connected to the first vibrating plate, the second end of the voice coil is suspended in the magnetic gap, and the outer edges of both the diaphragm and the second diaphragm assembly are connected to the housing, and the inner edges of both the diaphragm and the second diaphragm assembly are connected to the first diaphragm assembly, to form the acoustic cavity between the diaphragm and the second diaphragm assembly, and the sound output hole is provided at the housing. Thus, the acoustic cavity is in communication with the sound output hole, making the voice coil drive the diaphragm and the second diaphragm assembly to vibrate through the first diaphragm assembly. As a result, adding the diaphragm and the second diaphragm assembly on the basis of the conventional speaker, by utilizing the fact that when the sound emitting device works, the voice coil drives the diaphragm and the second diaphragm assembly to vibrate through the first diaphragm assembly, causing the volume between the diaphragm and the second diaphragm assembly to relatively change to push the air in the acoustic cavity to circulate smoothly through the sound output hole, to increase the effective vibration area when the sound emitting device vibrates, improving the performance of the sound emitting device

### BRIEF DESCRIPTION OF THE DRAWINGS

In order to more clearly illustrate the technical solutions in the embodiments of the present application or in the related art, the drawings needing to be used in the description of the embodiments or the related art will be briefly described below. Obviously, the drawings in the following description are only some embodiments of the present application. For those skilled in the art, other drawings can also be obtained based on the structures shown in these drawings without any creative effort.

FIG. 1 is a schematic structural view of a sound emitting device according to an embodiment of the present application.

FIG. 2 is an exploded schematic diagram of the sound emitting device according to an embodiment of the present application.

FIG. 3 is a schematic cross-sectional diagram of the sound emitting device according to an embodiment of the present application.

FIG. 4 is a schematic cross-sectional diagram of the sound emitting device from another perspective according to an embodiment of the present application.

FIG. 5 is a partial top schematic structural view of the sound emitting device according to an embodiment of the present application.

FIG. 6 is a top schematic structural view of the connection of a magnetic circuit system, a centring disk, and a voice coil in the sound emitting device according to an embodiment of the present application.

FIG. 7 is an exploded schematic diagram of the magnetic circuit system according to an embodiment of the present application.

FIG. 8 is an exploded schematic diagram of a first diaphragm assembly according to an embodiment of the present application.

FIG. 9 is a schematic structural view of a first vibrating plate according to an embodiment of the present application.

FIG. 10 is a schematic structural view of a second vibrating plate according to an embodiment of the present application.

FIG. 11 is a schematic structural view of a second vibrating plate according to another embodiment of the present application.

FIG. 12 is a schematic structural view of a diaphragm according to an embodiment of the present application.

FIG. 13 is a schematic structural view of a diaphragm according to another embodiment of the present application.

FIG. 14 is a schematic structural view of a centring disk according t an embodiment of the present application.

FIG. 15 is a schematic cross-sectional diagram of a sound emitting module according to an embodiment of the present application.

FIG. 16 is a schematic cross-sectional diagram of the sound emitting module from another perspective according to an embodiment of the present application.

The realization of the objectives, functional features and advantages of the present application will be further described in combination with the embodiments and with reference to the accompanying drawings.

### DETAILED DESCRIPTION OF THE EMBODIMENTS

The technical solutions in the embodiments of the present application will be clearly and completely described below in conjunction with the drawings in the embodiments of the present application. Obviously, the described embodiments are only a part of the embodiments of the present application, rather than all of the embodiments. Based on the embodiments in the present application, all other embodiments obtained by those of ordinary skill in the art without creative effort shall fall within the protection scope of the present application.

It should be noted that all directional indications (such as up, down, left, right, front, back . . . ) in the embodiments of the present application are only configured to explain the relative position relationship, movement situation, etc., between various components under a specific posture (as shown in the drawings). If the specific posture changes, the directional indications change accordingly.

At the same time, the meaning of “and/or,” or “and/or” appearing throughout the text is that it includes three solutions. Taking “A and/or B” as an example, it includes solution A, or solution B, or a solution where both A and B are satisfied.

In addition, descriptions involving “first”, “second”, etc., in the present application are only configured for descriptive purposes, and cannot be understood as indicating or implying their relative importance or implicitly indicating the number of indicated technical features. Therefore, features defined with “first” and “second” can explicitly or implicitly include at least one of such features. In addition, the technical solutions between various embodiments can be combined with each other, but it must be based on what can be achieved by those of ordinary skill in the art. When the combination of technical solutions is contradictory or cannot be achieved, it should be considered that such combination of technical solutions does not exist, and is not within the protection scope claimed by the present application.

In recent years, with the rapid development of consumer electronic products, people's requirements for electronic products are constantly increasing. In addition to differences in product performance itself, aspects such as portability and comfort are the focus of people's attention. At present, conventional speaker solutions in electronic products are difficult to balance various design requirements such as high performance and thinness at the same time.

The sound emitting device is an important electroacoustic energy conversion component in consumer electronic products, and it is widely applied as speakers, receivers, earphones, and the like. With the improvement of the performance of electronic products, the improvement of the acoustic performance of related sound emitting devices is also an inevitable trend.

A sound emitting device in the related art includes a frame, a vibration system fixed to the frame, and a magnetic circuit system having a magnetic gap. The magnetic circuit system drives the vibration system to vibrate and emit sound. The vibration system includes a diaphragm fixed to the frame configured for vibrating and emitting sound, a dome attached to the diaphragm, and a voice coil inserted into the magnetic gap and connected to the dome to drive the diaphragm to vibrate. That is, the sound emitting device drives the diaphragm in the vibration system to vibrate through the magnetic circuit system, repeatedly pushing air to realize sound emission. As the core component of the sound emitting device, the diaphragm directly affects the acoustic performance of the sound emitting device. The effective vibration area (Sd) of the diaphragm is one of the important factors affecting the acoustic performance of the sound emitting device. The larger the effective vibration area of the diaphragm, the better the acoustic performance of the sound emitting device.

However, in the sound emitting device of the related art, the vibration system and the magnetic circuit system present an up-and-down stacked structure, and the structure of the magnetic circuit system is limited in a sound emitting device of the same height, limiting its magnetic field BL value; in addition, the effective vibration area of the diaphragm of the sound emitting device in the related art is small, causing the acoustic performance of the sound emitting device to be affected.

Based on the above concepts and problems, the present application provides a sound emitting device 100. It can be understood that the sound emitting device 100 is applied to an electronic device, and the electronic device can be a mobile phone, an earphone, a smart wearable device, etc., which is not limited herein. In this embodiment, the sound emitting device 100 of the present application adds a diaphragm 34 and a second diaphragm assembly 32 on the basis of a conventional speaker, and utilizes the fact that the volume between the diaphragm 34 and the second diaphragm assembly 32 relatively changes during the operation of the sound emitting device 100 to push the air, realizing the increase of the effective vibration area when the sound emitting device 100 vibrates, thus improving the performance of the sound emitting device 100.

It can be understood that the sound emitting device 100 of the present application utilizes the Z-direction space of the sound emitting device 100 to increase the effective vibration area, increasing the effective vibration area (Sd) of the sound emitting device 100. At the same time, it makes up for the loss of Sd of the first diaphragm assembly 31 caused by the addition of magnets in the intermediate magnetic circuit of the magnetic circuit system. Moreover, since the intermediate magnetic circuit adds magnets, the magnetic field strength of the magnetic gap 24 is improved, improving the performance of the sound emitting device 100. The sound emitting device 100 of the present application balances its high performance and thinness solution at the same time. Compared with the conventional speaker, the performance of the sound emitting device 100 is improved under the same amplitude condition. Also, under the condition of the same performance, the amplitude of the sound emitting device 100 can be reduced, making the product size thinner.

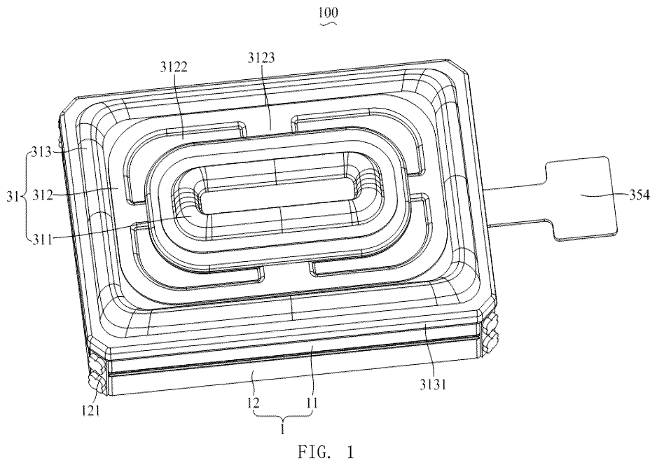

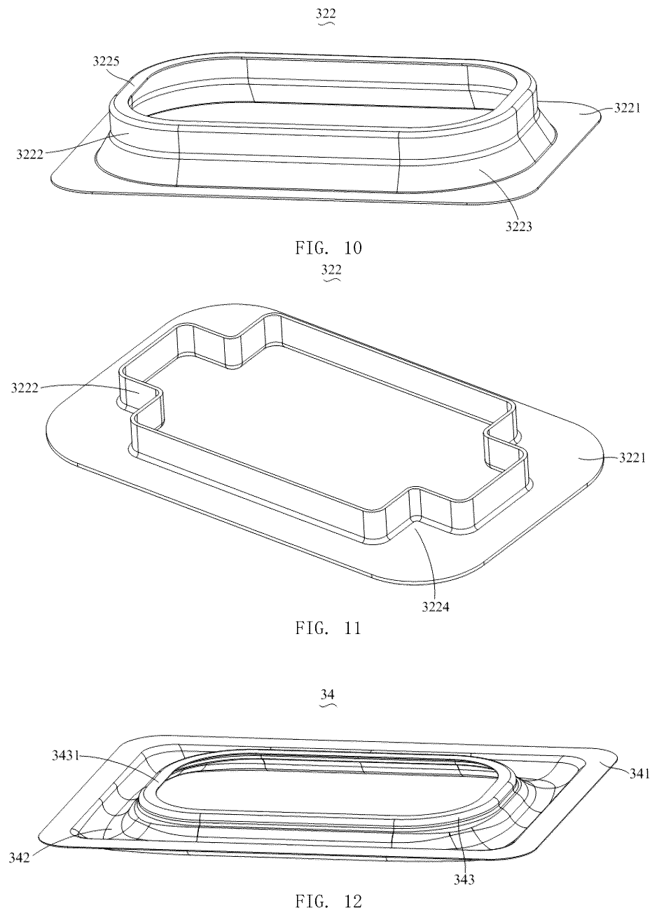

Referring to FIG. 1 to FIG. 14 in combination, in the embodiment of the present application, the sound emitting device 100 includes a housing 1, a magnetic circuit system 2, and a vibration system 3. Among them, the housing 1 is provided with a sound output hole 111, the magnetic circuit system 2 is connected to the housing 1, the magnetic circuit system 2 is provided with a magnetic gap 24, the vibration system 3 includes a first diaphragm assembly 31, a second diaphragm assembly 32, a voice coil 33, and a diaphragm 34. The first diaphragm assembly 31 includes an inner folded ring 311, a first vibrating plate 312, and an outer folded ring 313 which are connected in sequence. An inner side of the inner folded ring 311 is connected to the magnetic circuit system 2. An outer peripheral edge of the outer folded ring 313 is connected to the housing 1. A first end of the voice coil 33 is connected to the first vibrating plate 312, and a second end of the voice coil 33 is suspended in the magnetic gap 24. The diaphragm 34 and the second diaphragm assembly 32 are sequentially provided at a side of the first diaphragm assembly 31 facing the voice coil 33 and are provided at an outer side of the voice coil 33. Outer edges of both the diaphragm 34 and the second diaphragm assembly 32 are connected to the housing 1. Inner edges of both the diaphragm 34 and the second diaphragm assembly 32 are connected to the first diaphragm assembly 31 to form an acoustic cavity 41 communicating with the sound output hole 111 between the diaphragm 34 and the second diaphragm assembly 32.

In this embodiment, the sound emitting device 100 can be a sound emitting unit of a speaker, and the speaker can be a micro speaker. It should be noted that the magnetic circuit system 2 and the vibration system 3 of the sound emitting device 100 are provided opposite to each other.

In an embodiment, the magnetic circuit system 2 is provided in a square shape. In this embodiment, the vibration system 3 is optionally provided in a square shape. It can be understood that the peripheral edge of the first diaphragm assembly 31 of the vibration system 3 can be connected to the magnetic circuit system 2, or the magnetic circuit system 2 and the vibration system 3 can be respectively assembled on a speaker housing, etc., which is not limited herein.

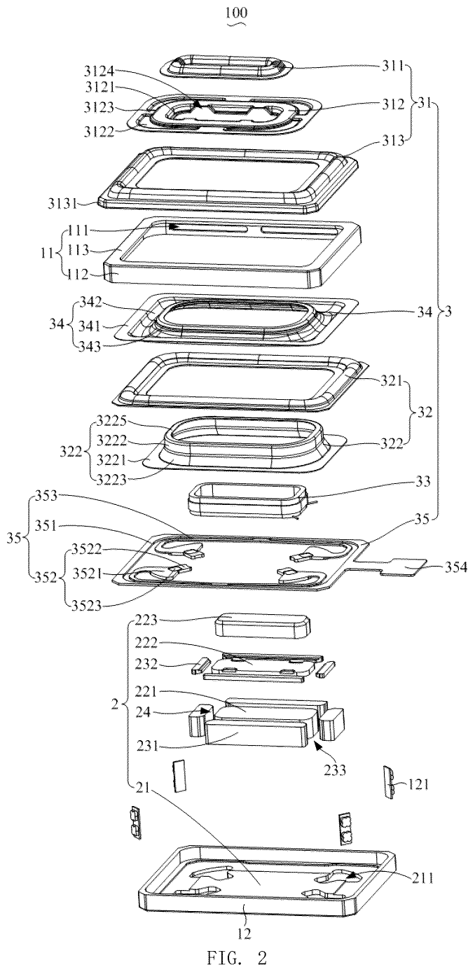

In this embodiment, as shown in FIG. 2 to FIG. 7, the magnetic circuit system 2 includes a magnetic yoke 21, and a central magnetic portion 22 and a side magnetic portion 23 provided at the magnetic yoke 21. The side magnetic portion 23 is provided at an outer side of the central magnetic portion 22, and forms the magnetic gap 24 together with the central magnetic portion 22. In an embodiment, both the central magnetic portion 22 and the side magnetic portion 23 of the magnetic circuit system 2 can be square structures.

In order to better assemble the magnetic circuit system 2 and the vibration system 3 of the sound emitting device 100. In an embodiment, as shown in FIG. 1 to FIG. 4, the sound emitting device 100 further includes a housing 1, and the magnetic circuit system 2 and the vibration system 3 are both connected to the housing 1. Specifically, the magnetic yoke 21 of the magnetic circuit system 2 is connected to one end of the housing 1, the peripheral edge of the first diaphragm assembly 31 of the vibration system 3 is connected to the other end of the housing 1, and is opposite to the magnetic circuit system 2, and the inner peripheral edge of the first diaphragm assembly 31 is connected to the magnetic circuit system 2. In an embodiment, the inner peripheral edge of the first diaphragm assembly 31 is connected to the central magnetic portion 22.

In this embodiment, the housing 1 is configured to mount, fix, and support components such as the magnetic circuit system 2 and the vibration system 3, that is, the housing 1 provides an installation basis for components such as the magnetic circuit system 2 and the vibration system 3. It can be understood that the housing 1 can be an integral structure, or it can be formed by cooperation of a plurality of split structures, which is not limited herein. The housing 1 in this embodiment is optionally a square frame or framework structure, that is, the housing 1 has a cavity open at both ends, and the magnetic circuit system 2 and the vibration system 3 are respectively connected to two sides of the housing 1, so that the magnetic circuit system 2, the housing 1, and the first diaphragm assembly 31 of the vibration system 3 enclose to form a vibration cavity.

In this embodiment, the housing 1 is configured to accommodate and fix structures such as the vibration system 3 and the magnetic circuit system 2, so that the sound emitting device 100 can be applied to an electronic device or a sound emitting module as an independent component, which is not limited herein.

It can be understood that by setting the magnetic circuit system 2 as the magnetic yoke 21, and the central magnetic portion 22 and the side magnetic portion 23 provided at the magnetic yoke 21, the magnetic circuit system 2 can be connected to the housing 1 through the peripheral edge of the magnetic yoke 21 at this time. In this embodiment, the side magnetic portion 23 is provided at the outer side of the central magnetic portion 22, and forms the magnetic gap 24 together with the central magnetic portion 22, so that the first diaphragm assembly 31 of the vibration system 3 is connected to an end of the housing 1 away from the magnetic yoke 21, the inner side of the first diaphragm assembly 31 is connected to the central magnetic portion 22, and the first end of the voice coil 33 is connected to the first diaphragm assembly 31, and the second end of the voice coil 33 is suspended in the magnetic gap 24. Thus, current is passed into the voice coil 33, so that the voice coil 33 converts electrical energy into mechanical energy in the magnetic gap 24 formed by the magnetic circuit system 2 to drive the voice coil 33 to drive the first diaphragm assembly 31 to vibrate, realizing sound emission.

In an embodiment, the central magnetic portion 22 includes a first central magnet 221, a central pole plate 222, and a second central magnet 223 which are stacked. The first central magnet 221 is connected to the magnetic yoke 21, and the inner side of the inner folded ring 311 is connected to the second central magnet 223. Among them, the first central magnet 221 and the second central magnet 223 are both magnetized along the vibration direction of the vibration system 3, and the magnetization directions are opposite.

In this embodiment, as shown in FIG. 2 to FIG. 7, by setting the central magnetic portion 22 as a counter-magnetic structure, the first central magnet 221, the central pole plate 222, and the second central magnet 223 of the central magnetic portion 22 are stacked on the magnetic yoke 21 in sequence along the vertical direction. The first central magnet 221 and the second central magnet 223 are both magnetized along the vibration direction of the vibration system 3, and the magnetization direction of the first central magnet 221 is opposite to the magnetization direction of the second central magnet 223. In this way, by utilizing the magnetic conduction effect of the central pole plate 222, the magnetic lines of force of the first central magnet 221 and the second central magnet 223 are gathered at the central pole plate 222, and transmitted to the magnetic gap 24 by the central pole plate 222, so that the central magnetic portion 22 generates a magnetic field with a strong magnetic field strength passing through the magnetic gap 24, increasing the density of the magnetic flux of the magnetic gap 24, increasing the number of magnetic lines of force passing through the voice coil 33, increasing the magnetic force received by the voice coil 33, and effectively improving the BL value.

It can be understood that by setting the first diaphragm assembly 31 as the inner folded ring 311, the first vibrating plate 312, and the outer folded ring 313 which are connected in sequence, the inner side of the inner folded ring 311 is connected to the second central magnet 223 of the central magnetic portion 22, and the outer peripheral edge of the outer folded ring 313 is connected to the housing 1, realizing the fixed connection of the first diaphragm assembly 31. At the same time, the vibration performance and compliance of the first diaphragm assembly 31 are improved by the inner folded ring 311 and the outer folded ring 313. In an embodiment, the first vibrating plate 312 is connected to the voice coil 33; or, the first vibrating plate 312 is connected to the voice coil 33 through a connector or a framework, which is not limited herein.

In an embodiment, the material of the first vibrating plate 312 is a metal material or a fiber material. In this embodiment, the vibrating plate is respectively adhered or integrally injection-molded with the outer folded ring 313 and the inner folded ring 311. It should be noted that the inner folded ring 311, the first vibrating plate 312, and the outer folded ring 313 of the first diaphragm assembly 31 can also be an integrally formed structure. In this way, the structural strength of the first diaphragm assembly 31 can be ensured, and the processing steps can be simplified, which is not limited herein.

In this embodiment, an outer peripheral edge of the first vibrating plate 312 forms a first step surface, and an inner peripheral edge of the first vibrating plate 312 forms a second step surface; an inner side of the outer folded ring 313 extends along a direction perpendicular to the vibration direction of the vibration system 3 to form an inner loop portion, and an outer side of the inner folded ring 311 extends along a direction perpendicular to the vibration direction of the vibration system 3 to form an outer loop portion. Among them, the inner loop portion overlaps the first step surface and is bonded and connected to the first step surface, and the outer loop portion overlaps the second step surface and is bonded and connected to the second step surface.

It can be understood that the first vibrating plate 312 is bonded and connected to the outer folded ring 313 and the inner folded ring 311 respectively, which not only improves the connection stability, but also makes the assembly structure more compact, and ensures the vibration performance of the entire first diaphragm assembly 31. In other embodiments, the inner loop portion of the outer folded ring 313 and the outer loop portion of the inner folded ring 311 can be simultaneously connected to the same side of the first vibrating plate 312 (for example, the upper surface of the first vibrating plate 312 or the lower surface of the first vibrating plate 312), or the inner loop portion of the outer folded ring 313 and the outer loop portion of the inner folded ring 311 can be connected to different sides of the first vibrating plate 312, which is not limited herein.

In this embodiment, as shown in FIG. 1 to FIG. 4 and FIG. 8, the inner folded ring 311 of the first diaphragm assembly 31 can be a sealed structure, that is, the inner side of the inner folded ring 311 presents a flat plate shape, and the inner side flat plate shape of the inner folded ring 311 is connected and fitted to a side of the central magnetic portion 22 of the magnetic circuit system 2 facing away from the magnetic yoke 21.

In other embodiments, the first diaphragm assembly 31 is optionally an annular structure. It can be understood that the inner side of the inner folded ring 311 is provided with a hollowed-out hole, and a part of the central magnetic portion 22 is exposed from the hollowed-out hole, or a part of the central magnetic portion 22 passes through the hollowed-out hole, which is not limited herein.

In this embodiment, the outer folded ring 313 and the inner folded ring 311 of the first diaphragm assembly 31 can be an upwardly protruding convex structure or a downwardly recessed recess structure, which is not limited herein. In order to avoid the diaphragm 34 and the second diaphragm assembly 32, the outer folded ring 313 of the first diaphragm assembly 31 optionally protrudes in a direction away from the magnetic circuit system 2. It can be understood that in order to avoid interference between the inner folded ring 311 of the first diaphragm assembly 31 and the central magnetic portion 22 of the magnetic circuit system 2 during vibration, the inner folded ring 311 of the first diaphragm assembly 31 optionally protrudes in a direction away from the magnetic circuit system 2. In an embodiment, both the inner folded ring 311 and the outer folded ring 313 protrude in a direction away from the magnetic circuit system 2.

In order to further increase the connection area between the outer folded ring 313 of the first diaphragm assembly 31 and the housing 1 and improve stability, in this embodiment, as shown in FIG. 1 to FIG. 4 and FIG. 8, the outer peripheral edge of the outer folded ring 313 is bent and extends to form a third flange 3131, and the third flange 3131 is connected to the outer wall of the housing 1. It can be understood that the outer peripheral edge of the outer folded ring 313 has a flat portion parallel to the first vibrating plate 312, and the flat portion is connected to the end face of the housing 1. The third flange 3131 is bent and extends from the outer side of the flat portion toward the direction approaching the magnetic circuit system 2, so that the third flange 3131 is connected to the outer side wall of the housing 1, increasing the connection area with the housing 1 and improving connection stability and waterproof sealing performance.

In order to realize the electrical connection between the voice coil 3 and an external circuit. In an embodiment, as shown in FIG. 2 to FIG. 6 and FIG. 14, the vibration system 3 further includes a centring disk 35. One end of the centring disk 35 is connected to the voice coil 33 and connected and conducted with a lead wire of the voice coil 33, and the other end of the centring disk 35 is connected to the housing 1.

It can be understood that both ends of the centring disk 35 are respectively electrically connected to the lead wire of the voice coil 33 and the external circuit. In this embodiment, the centring disk 35 can be provided at the bottom of the voice coil 33. The centring disk 35 is provided at four corner positions of the sound emitting device 100 or along a minor axis or major axis direction of the sound emitting device 100. In an embodiment, the centring disk 35 can also be provided at the top of the voice coil 33, and the centring disk 35 is provided between the voice coil 33 and the diaphragm 31, which is not limited herein.

In this embodiment, the diaphragm 34 and the second diaphragm assembly 32 of the vibration system 3 are sequentially provided at a side of the first diaphragm assembly 31 facing the magnetic yoke 21, and are provided at the outer side of the voice coil 33, that is, the diaphragm 34 and the second diaphragm assembly 32 are sequentially provided below the first diaphragm assembly 31. The outer edges of both the diaphragm 34 and the second diaphragm assembly 32 are connected to the housing 1, and the inner edges of both the diaphragm 34 and the second diaphragm assembly 32 are connected to the first diaphragm assembly 31 to form the acoustic cavity 41 between the diaphragm 34 and the second diaphragm assembly 32. The sound output hole 111 is provided at the housing 1, so that the acoustic cavity 41 is in communication with the sound output hole 111. In this way, the voice coil 33 drives the diaphragm 34 and the second diaphragm assembly 32 to vibrate through the first diaphragm assembly 31.

In an embodiment, the inner edge of the diaphragm 34 and the inner edge of the second diaphragm assembly 32 are both connected to the first vibrating plate 312, improving the connection strength of the diaphragm 34 and the second diaphragm assembly 32 and the first diaphragm assembly 31. In this way, the voice coil 33 drives the diaphragm 34 and the second diaphragm assembly 32 to vibrate through the first vibrating plate 312 of the first diaphragm assembly 31.

It can be understood that when current is passed into the voice coil 33, the voice coil 33 converts electrical energy into mechanical energy in the magnetic gap 24 formed by the magnetic circuit system 2, to drive the voice coil 33 to drive the first diaphragm assembly 31 to vibrate, realizing sound emission. At the same time, the voice coil 33 drives the diaphragm 34 and the second diaphragm assembly 32 to vibrate through the first vibrating plate 312, so that the volume between the diaphragm 34 and the second diaphragm assembly 32 relatively changes to push the air in the acoustic cavity 41 to circulate smoothly through the sound output hole 111. At this time, the sound emitting device 100 adds the diaphragm 34 and the second diaphragm assembly 32 on the basis of a conventional speaker. By utilizing the fact that when the sound emitting device 100 works, the voice coil 33 simultaneously drives the first diaphragm assembly 31, the second diaphragm assembly 32, and the diaphragm 34 to vibrate, the effective vibration area when the sound emitting device 100 vibrates is increased, improving the performance of the sound emitting device 100.

In this embodiment, the structure of the second diaphragm assembly 32 can be a diaphragm structure or other structures capable of vibrating and emitting sound, which is not limited herein. The structure of the diaphragm 34 can be a structure capable of vibration and deformation. In an embodiment, the diaphragm 34 is a flexible element. The diaphragm 34 is a single-layer PEEK (polyetheretherketone) film, a composite PEEK (polyetheretherketone) film, or other flexible materials. It can be understood that by connecting the inner edge of the diaphragm 34 and the inner edge of the second diaphragm assembly 32 both to the first vibrating plate 312, the voice coil 33 drives the diaphragm 34 and the second diaphragm assembly 32 to vibrate through the first vibrating plate 312. The first vibrating plate 312 can be a metal material such as stainless steel or other materials with a certain strength such as carbon fiber, which is not limited herein.

It should be noted that the acoustic cavity 41 formed between the diaphragm 34 and the second diaphragm assembly 32 is a sealed front cavity. When the sound emitting device 100 works, the vibration directions of the first diaphragm assembly 31 and the second diaphragm assembly 32 are the same. Utilizing the volume change of the acoustic cavity 41 to increase the volume of air pushed during operation, realizing an increase in the effective vibration area of the product. At the same time, by providing the diaphragm 34 and the second diaphragm assembly 32, the sound emitting device 100 utilizes its own Z-direction space to increase the effective vibration area to increase the Sd of the sound emitting device 100, and at the same time reduces the loss of Sd caused by the connection between the inner folded ring 311 of the first diaphragm assembly 31 and the central magnetic portion 22, improving the performance of the sound emitting device 100.

In an embodiment, the effective vibration area Sd1 of the diaphragm 34 is smaller than the effective vibration area Sd2 of the second diaphragm assembly 32. In this embodiment, the ratio of Sd1 to Sd2 is 1:1.5 to 1:3. In an embodiment, the ratio of the effective vibration area Sd1 of the diaphragm 34 to the effective vibration area Sd2 of the second diaphragm assembly 32 can be 1:1.5, 1:1.8, 1:2, 1:2.3, 1:2.5, 1:2.8, 1:3, etc., which is not limited herein.

It can be understood that such a setting allows the diaphragm 34 to vibrate and deform when the voice coil 33 drives the diaphragm 34 and the second diaphragm assembly 32 to vibrate through the first vibrating plate 312, causing the diaphragm 34 to play a counteracting role in pushing the air volume, and the second diaphragm assembly 32 to play a positive role in pushing the air volume. Utilizing the volume change of the acoustic cavity 41 to increase the air volume pushed during operation, realizing an increase in the effective vibration area of the product.

The sound emitting device 100 of the present application accommodates the magnetic circuit system 2 and the vibration system 3 in the housing 1, and sets the magnetic circuit system 2 as the magnetic yoke 21 and the central magnetic portion 22 and the side magnetic portion 23 provided at the magnetic yoke 21. Thus, the side magnetic portion 23 is provided at the outer side of the central magnetic portion 22, and forms the magnetic gap 24 together with the central magnetic portion 22, and sets the first diaphragm assembly 31, the second diaphragm assembly 32, the voice coil 33, and the diaphragm 34 in the vibration system 3. As a result, the inner side of the inner folded ring 311 of the first diaphragm assembly 31 is connected to the central magnetic portion 22 of the magnetic circuit system 2, the outer peripheral edge of the outer folded ring 313 is connected to the housing 1, the first end of the voice coil 33 is connected to the first diaphragm assembly 31, and the second end of the voice coil 33 is suspended in the magnetic gap 24. Thus, current is passed into the voice coil 33, making the voice coil 33 convert electrical energy into mechanical energy in the magnetic gap 24 formed by the magnetic circuit system 2, to drive the voice coil 33 to drive the first diaphragm assembly 31 to vibrate, realizing sound emission; at the same time, the diaphragm 34 and the second diaphragm assembly 32 are sequentially provided at a side of the first diaphragm assembly 31 facing the magnetic yoke 21 and are provided at the outer side of the voice coil 33. Thus, the outer edges of both the diaphragm 34 and the second diaphragm assembly 32 are connected to the housing 1, and the inner edges of both the diaphragm 34 and the second diaphragm assembly 32 are connected to the first diaphragm assembly 31, to form the acoustic cavity 41 between the diaphragm 34 and the second diaphragm assembly 32, and the sound output hole 111 is provided at the housing 1. As a result, the acoustic cavity 41 is in communication with the sound output hole 111. Thus, the voice coil 33 drives the diaphragm 34 and the second diaphragm assembly 32 to vibrate through the first vibrating plate 312. By adding the diaphragm 34 and the second diaphragm assembly 32 on the basis of a conventional speaker, utilizing the fact that when the sound emitting device 100 works, the voice coil 33 drives the diaphragm 34 and the second diaphragm assembly 32 to vibrate through the first diaphragm assembly 31, making the volume between the diaphragm 34 and the second diaphragm assembly 32 relatively change to push the air in the acoustic cavity 41 to circulate smoothly through the sound output hole 111, to increase the effective vibration area when the sound emitting device 100 vibrates, improving the performance of the sound emitting device 100; further, by making the central magnetic portion 22 a counter-magnetic structure, this can improve the magnetic field strength of the magnetic circuit system 2 of the sound emitting device 100, improving the performance of the sound emitting device 100 as a whole.

In an embodiment, the first vibrating plate 312 extends in a bending manner toward the voice coil 33 to form a second bent portion 3121, and the second bent portion 3121 is connected to the voice coil 33.

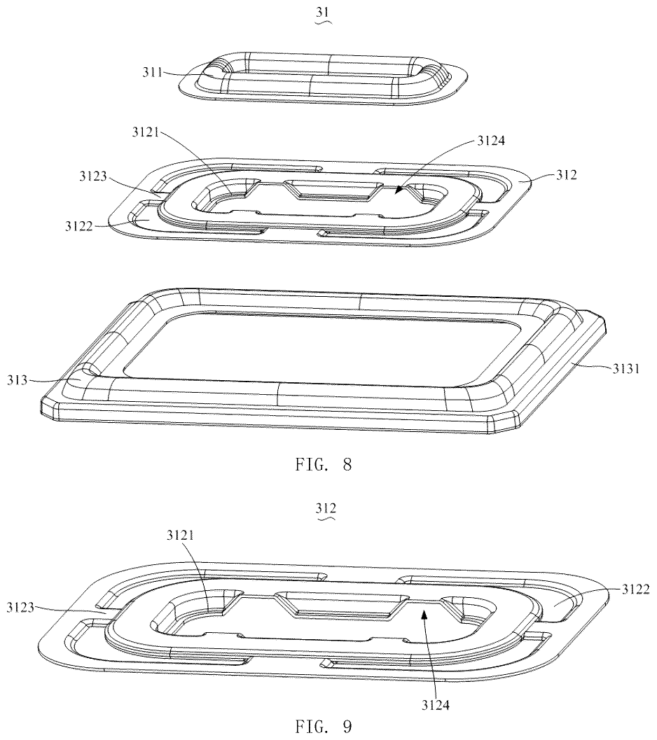

In this embodiment, as shown in FIG. 2 to FIG. 4, FIG. 8, and FIG. 9 by providing the second bent portion 3121 at the first vibrating plate 312, the second bent portion 3121 extends toward the voice coil 33, so that the first vibrating plate 312 is connected to the voice coil 33 through the second bent portion 3121, utilizing the second bent portion 3121 to suspend the voice coil 33 at a relatively reasonable position in the magnetic gap 24 to ensure the effect of the magnetic circuit system 2 driving the voice coil 33 to vibrate.

It can be understood that the second bent portion 3121 is formed by bending and extending from the inner side of the first vibrating plate 312 toward the direction approaching the voice coil 33. In an embodiment, the first vibrating plate 312 and the second bent portion 3121 are an integrally formed structure, such as integral injection molding or integral stamping molding, which is not limited herein.

In an embodiment, the second bent portion 3121 can be an integral ring-shaped structure formed by bending, so that the end face of the voice coil 33 adjacent to one end of the first vibrating plate 312 is connected to the second bent portion 3121. Alternatively, the second bent portion 3121 includes a plurality of second bent portions 3121, and the plurality of second bent portions 3121 are spaced apart and provided in an annular structure corresponding to the voice coil 33, so that the plurality of second bent portions 3121 are connected to the end face of the voice coil 33 adjacent to one end of the first vibrating plate 312, which is not limited herein.

In another embodiment, the first diaphragm assembly 31 further includes a first bracket, and two ends of the first bracket are respectively connected to the first vibrating plate 312 and the voice coil 33. It can be understood that the first bracket can be connected to the first vibrating plate 312 through bonding, welding, or integral injection molding, so that the first vibrating plate 312 is connected to the voice coil 33 through the first bracket, utilizing the first bracket to suspend the voice coil 33 at a relatively reasonable position in the magnetic gap 24 to ensure the effect of the magnetic circuit system 2 driving the voice coil 33 to vibrate.

In an embodiment, the first bracket forms an annular structure, so that the end face of the voice coil 33 adjacent to one end of the first vibrating plate 312 is connected to the first bracket. Alternatively, the first bracket includes a plurality of first brackets, and the plurality of first brackets are spaced apart and form an annular structure corresponding to the voice coil 33, so that the plurality of first brackets are all connected to the end face of the voice coil 33 adjacent to one end of the first vibrating plate 312, which is not limited herein.

In an embodiment, the inner edge of the diaphragm 34 and the inner edge of the second diaphragm assembly 32 are both connected to the first vibrating plate 312, the first vibrating plate 312 is provided with a protruding portion 3122 approaching the diaphragm 34, and the inner edge of the diaphragm 34 and the inner edge of the second diaphragm assembly 32 are both connected to the protruding portion 3122.

In this embodiment, as shown in FIG. 2 to FIG. 4, FIG. 8, and FIG. 9 by providing the protruding portion 3122 at the first vibrating plate 312, the protruding portion 3122 extends toward the diaphragm 34, so that the first vibrating plate 312 is connected to the inner edge of the diaphragm 34 and the inner edge of the second diaphragm assembly 32 through the protruding portion 3122, utilizing the protruding portion 3122 to support the diaphragm 34 and the second diaphragm assembly 32 away from the first diaphragm assembly 31, effectively avoiding interference between the diaphragm 34 and the second diaphragm assembly 32 and the first diaphragm assembly 31, to ensure the vibration effect.

It can be understood that the protruding portion 3122 is formed by bending and extending from the inner side of the first vibrating plate 312 toward the direction approaching the diaphragm 34. In an embodiment, the first vibrating plate 312 and the protruding portion 3122 are an integrally formed structure, such as integral injection molding or integral stamping molding, which is not limited herein. In this embodiment, as shown in FIG. 2, FIG. 8, and FIG. 9, a side of the first vibrating plate 312 facing away from the diaphragm 34 is recessed toward the side approaching the diaphragm 34, to protrude at the side of the first vibrating plate 312 facing the diaphragm 34 to form the protruding portion 3122, which is not limited herein.

In an embodiment, the protruding portion 3122 can be an integral annular structure; or, the protruding portion 3122 includes a plurality of protruding portions 3122, and the plurality of protruding portions 3122 are spaced apart and form an annular structure, which is not limited herein.

In another embodiment, the first diaphragm assembly 31 further includes a second bracket, a first end of the second bracket is connected to the first vibrating plate 312, and a second end of the second bracket is connected to the inner edge of the diaphragm 34 and the inner edge of the second diaphragm assembly 32.

It can be understood that the second bracket can be connected to the first vibrating plate 312 through bonding, welding, or integral injection molding, so that the first vibrating plate 312 is connected to the inner edge of the diaphragm 34 and the inner edge of the second diaphragm assembly 32 through the second bracket, utilizing the second bracket to support the diaphragm 34 and the second diaphragm assembly 32 away from the first diaphragm assembly 31, effectively avoiding interference between the diaphragm 34 and the second diaphragm assembly 32 and the first diaphragm assembly 31, to ensure the vibration effect.

In an embodiment, the second bracket forms an annular structure; or, the second bracket includes a plurality of second brackets, and the plurality of second brackets are spaced apart and form an annular structure, which is not limited herein.

In an embodiment, a first rear cavity 42 is enclosed between the first diaphragm assembly 31 and the diaphragm 34, and a second rear cavity 43 is enclosed among the first diaphragm assembly 31, the second diaphragm assembly 32, the housing 1, and the magnetic circuit system 2; the first vibrating plate 312 is provided with a protruding portion 3122 approaching the diaphragm 34, and the inner edge of the diaphragm 34 and the inner edge of the second diaphragm assembly 32 are both connected to the protruding portion 3122; the protruding portion 3122 is provided with an airflow channel 3123 communicating the first rear cavity 42 with the second rear cavity 43.

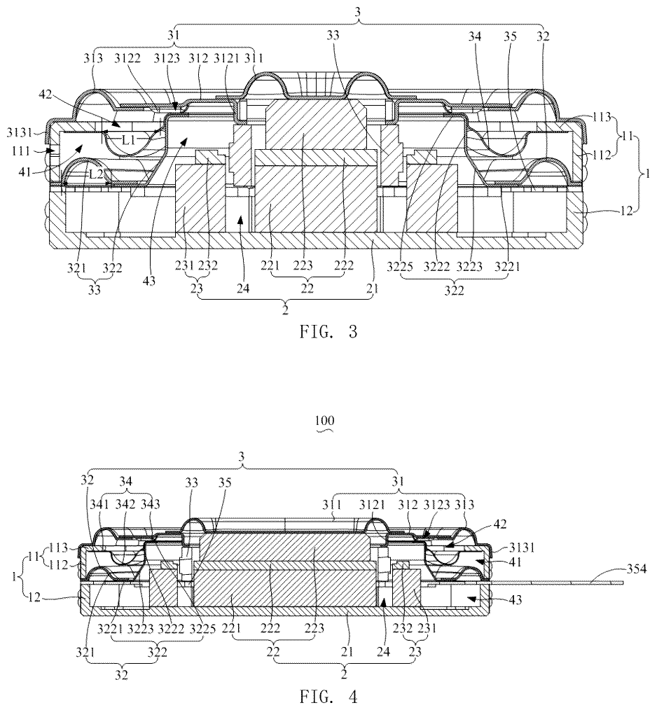

In this embodiment, as shown in FIG. 3 and FIG. 4, the outer side o the outer folded ring 313 of the first diaphragm assembly 31 is connected to the housing 1, the inner side of the inner folded ring 311 of the first diaphragm assembly 31 is connected to the central magnetic portion 22 of the magnetic circuit system 2, the outer side of the diaphragm 34 is connected to the housing 1, and the inner edge of the diaphragm 34 is connected to the first vibrating plate 312. Thus, the first rear cavity 42 is enclosed among the outer folded ring 313, the first vibrating plate 312, the diaphragm 34, and the housing 1 of the first diaphragm assembly 31. The outer side of the second diaphragm assembly 32 is connected to the housing 1, and the inner edge of the second diaphragm assembly 32 is connected to the first vibrating plate 312. As a result, the acoustic cavity 41 is enclosed among the diaphragm 34, the first vibrating plate 312, the second diaphragm assembly 32, and the housing 1. Also, the second rear cavity 43 is enclosed among the second diaphragm assembly 32, the first vibrating plate 312 of the first diaphragm assembly 31, the inner folded ring 311, the housing 1, and the magnetic yoke 21 of the magnetic circuit system 2.

It can be understood that, when the voice coil 33 drives the first diaphragm assembly 31, the diaphragm 34, and the second diaphragm assembly 32 to vibrate, in order to avoid an air pressure imbalance in the acoustic cavity 41, the first rear cavity 42, and the second rear cavity 43, the acoustic cavity 41 is in communication with the outside through the sound output hole 111, the first rear cavity 42 is in communication with the second rear cavity 43, and the second rear cavity 43 is connected to the outside through a vent hole at the housing 1 and/or the magnetic yoke 21 of the sound emitting device 100.

In this embodiment, as shown in FIG. 2 to FIG. 4, FIG. 8, and FIG. 9 by providing the first vibrating plate 312 with the protruding portion 3122 approaching the diaphragm 34, so that the inner edge of the diaphragm 34 and the inner edge of the second diaphragm assembly 32 are both connected to the protruding portion 3122, and the protruding portion 3122 is provided with the airflow channel 3123 communicating the first rear cavity 42 and the second rear cavity 43. This can not only utilize the protruding portion 3122 to realize the connection and fixation of the diaphragm 34 and the second diaphragm assembly 32, but also utilize the airflow channel 3123 of the protruding portion 3122 to realize the communication between the first rear cavity 42 and the second rear cavity 43, ensuring air pressure balance to ensure the sound emitting effect.

In an embodiment, the airflow channel 3123 includes a plurality of airflow channels 3123, and the plurality of airflow channels 3123 are spaced apart along the protruding portion 3122. Such a setting can ensure communication between the first rear cavity 42 and the second rear cavity 43, and avoid air pressure imbalance in the first rear cavity 42 from affecting the vibration effect of the diaphragm 34 and the first diaphragm assembly 31.

In other embodiments, the first diaphragm assembly 31 further includes a second bracket, the first end of the second bracket is connected to the first vibrating plate 312, and the second end of the second bracket is connected to the inner edge of the diaphragm 34 and the inner edge of the second diaphragm assembly 32. At this time, the second bracket is provided with the airflow channel 3123 communicating the first rear cavity 42 and the second rear cavity 43, which is not limited herein.

It can be understood that the airflow channel 3123 can be a through hole, notch, or other structures provided at the protruding portion 3122 or the second bracket, or it can be a convex structure formed by the first vibrating plate 312 or the protruding portion 3122 or the second bracket protruding in a direction away from the diaphragm 34, so that a through hole or channel structure is formed by cooperation between the inner edge of the diaphragm 34 and the inner edge of the second diaphragm assembly 32 and the convex structure, which is not limited herein.

In order to further improve the circulation of air pressure in the first rear cavity 42 and the second rear cavity 43, in an embodiment, the first vibrating plate 312 extends in a bending manner toward the voice coil 33 to form the second bent portion 3121, the second bent portion 3121 is connected to the voice coil 33, and the second bent portion 3121 is provided with a notch 3124. In this embodiment, as shown in FIG. 2, FIG. 8, and FIG. 9, by providing the notch 3124 at the second bent portion 3121, the airflow on both sides of the second bent portion 3121 can circulate through the notch 3124, improving the airflow circulation speed.

In other embodiments, the first diaphragm assembly 31 further includes a first bracket, and two ends of the first bracket are respectively connected to the first vibrating plate 312 and the voice coil 33. At this time, the first bracket is provided with the notch 3124, so that the air pressure on both sides of the first bracket can circulate through the notch 3124, improving the airflow circulation speed.

In an embodiment, the notch 3124 can be a through hole, notch, or other structures provided at the second bent portion 3121 or the first bracket, or it can be a convex structure formed by the second bent portion 3121 or the first bracket protruding in a direction away from the voice coil 33, making a through hole or channel structure formed by cooperation between the voice coil 33 and the convex structure, which is not limited herein.

In an embodiment, the second diaphragm assembly 32 includes a folded ring portion 321 and a second vibrating plate 322. An outer peripheral edge of the folded ring portion 321 is connected to the housing 1. The second vibrating plate 322 includes a main body portion 3221 connected to an inner edge of the folded ring portion 321 and a first bent portion 3222 extending in a bending manner from the main body portion 3221 toward the first diaphragm assembly 31. The first bent portion 3222 is connected to the inner edge of the first diaphragm assembly 31 and/or the diaphragm 34. In an embodiment, the first bent portion 3222 is connected to the first vibrating plate 312 of the first diaphragm assembly 31.

In this embodiment, the folded ring portion 321 of the second diaphragm assembly 32 can be an upwardly protruding convex structure or a downwardly recessed recess structure, that is, the folded ring portion 321 has an upwardly protruding or downwardly recessed deformation section, which is not limited herein. In order to facilitate the connection between the folded ring portion 321 and the housing 1, the outer peripheral edge of the folded ring portion 321 is bent to form a first flange, and the first flange is connected to the outer wall of the housing 1.

It can be understood that the first flange extends from the outer peripheral edge of the deformation section of the folded ring portion 321 along the vibration direction of the vibration system, and the first flange can be connected to the outer side wall of the housing 1, increasing the connection area between the folded ring portion 321 and the housing 1, and improving the connection stability and waterproof sealing performance. In an embodiment, the outer side of the deformation section of the folded ring portion 321 has a horizontal portion extending along a direction perpendicular to the vibration direction of the vibration system, and the horizontal portion is connected to the end face of the housing 1. The outer side of the horizontal portion extends along the vibration direction of the vibration system to form the first flange, which is not limited herein.

In this embodiment, by setting the second vibrating plate 322 as the main body portion 3221 and the first bent portion 3222, one end of the main body portion 3221 away from the first bent portion 3222 is connected to the inner edge of the folded ring portion 321, that is, the inner edge of the deformation section of the folded ring portion 321 is connected to the main body portion 3221, and the first bent portion 3222 is connected to the inner edge of the first vibrating plate 312 and/or the diaphragm 34, so as to form the acoustic cavity 41 with the diaphragm 34, the second vibrating plate 322 and the folded ring portion 321 of the second diaphragm assembly 32, and the housing 1. It can be understood that the second vibrating plate 322 of the second diaphragm assembly 32 is connected to the voice coil 33 through the first vibrating plate 312. In this way, when the voice coil 33 drives the diaphragm 34 and the second diaphragm assembly 32 to vibrate through the first vibrating plate 312, the second vibrating plate 322 of the second diaphragm assembly 32 drives the folded ring portion 321 to vibrate and deform.

In an embodiment, the folded ring portion 321 of the second diaphragm assembly 32 and the second vibrating plate 322 adopt adhesive connection or integral injection molding, which is not limited herein. In this embodiment, the main body portion 3221 and the first bent portion 3222 of the second vibrating plate 322 are an integrally formed structure, and the first bent portion 3222 extends in a bending manner from the main body portion 3221 toward the first vibrating plate 312, for example, through injection molding or stamping molding, which is not limited herein.

In an embodiment, an inclined portion 3223 is formed at a connection between the main body portion 3221 and the first bent portion 3222, and the inclined portion 3223 is provided at an angle with respect to the vibration direction of the vibration system 3.

It can be understood that, as shown in FIG. 2 to FIG. 4 and FIG. 10, the plane where the inclined portion 3223 is provided is provided at an angle to the vibration direction of the vibration system 3. The angle is optionally greater than 0° and less than 90°. The setting of the inclined portion 3223 can improve the rigidity of the second vibrating plate 322 in the horizontal direction (that is, perpendicular to the vibration direction of the vibration system 3), improving the vibration performance of the second diaphragm assembly 32, and improving the feasibility of molding. At the same time, relative to the inner edge of the second vibrating plate 322, the inclined portion 3223 is further away from the magnetic circuit system 2, which allows the outer edge of the magnetic circuit system 2 to tilt and expand outward, increasing the size of the magnetic circuit system 2 and further improving the BL value of the sound emitting device 100. Moreover, the inclined portion 3223 facilitates the positioning and connection between the second vibrating plate 322 and the folded ring portion 321, improving connection accuracy. In an embodiment, the second vibrating plate 322 can be a magnesium-aluminum alloy, a magnesium-lithium alloy, etc., which is not limited herein.

In an embodiment, the diaphragm 34 is a flexible element. The diaphragm 34 includes an outer connection portion 341, a deformation portion 342, and an inner connection portion 343 which are connected in sequence. An outer peripheral edge of the outer connection portion 341 is connected to the housing 1. An inner edge of the inner connection portion 343 is connected to the first diaphragm assembly 31 and/or the first bent portion 3222. The deformation portion 342 is in a bent shape. In an embodiment, the inner edge of the diaphragm 34 and the inner edge of the second diaphragm assembly 32 are both connected to the first vibrating plate 312.

In this embodiment, as shown in FIG. 2 to FIG. 5, FIG. 11, and FIG. by setting the diaphragm 34 as a flexible element, when the voice coil 33 drives the diaphragm 34 and the second diaphragm assembly 32 to vibrate through the first diaphragm assembly 31, the diaphragm 34 vibrates and deforms, so that the volume between the diaphragm 34 and the second diaphragm assembly 32 relatively changes to push the air in the acoustic cavity 41 to circulate smoothly through the sound output hole 111, to increase the effective vibration area when the sound emitting device 100 vibrates, improving the performance of the sound emitting device 100.

It can be understood that by providing the diaphragm 34 with the outer connection portion 341, the deformation portion 342, and the inner connection portion 343, so that the outer peripheral edge of the outer connection portion 341 is connected to the housing 1, and the inner edge of the inner connection portion 343 is connected to the first diaphragm assembly 31 and/or the first bent portion 3222. This not only allows the diaphragm 34 to be connected and fixed to the housing 1 through the outer connection portion 341, but also allows the inner connection portion 343 to be connected to the first diaphragm assembly 31, so that the sealed acoustic cavity 41 is formed between the diaphragm 34 and the second diaphragm assembly 32. At the same time, the deformation portion 342 is set in a bent shape, which improves the deformation capability of the diaphragm 34. Thus, when the voice coil 33 drives the diaphragm 34 and the second diaphragm assembly 32 to vibrate through the first diaphragm assembly 31, the diaphragm 34 vibrates and deforms, and at the same time, the second vibrating plate 322 of the second diaphragm assembly 32 drives the folded ring portion 321 to vibrate and deform.

In an embodiment, the inner edge of the inner connection portion 343 extends along the inner surface of the first diaphragm assembly 31 to form a second flange 3431. An end of the first bent portion 3222 adjacent to the first diaphragm assembly 31 forms a flat section 3225 extending along the inner surface of the first diaphragm assembly 31. Among them, the second flange 3431 is sandwiched between the first diaphragm assembly 31 and the flat section 3225; or, the flat section 3225 is sandwiched between the second flange 3431 and the first diaphragm assembly 31; or, both the second flange 3431 and the flat section 3225 are connected to the first diaphragm assembly 31.

Specifically and In an embodiment, the inner edge of the inner connection portion 343 extends along the inner surface of the first vibrating plate 312 to form the second flange 3431, and the end of the first bent portion 3222 adjacent to the first vibrating plate 312 is bent to form the flat section 3225 extending along the inner surface of the first vibrating plate 312. Among them, the second flange 3431 is sandwiched between the first vibrating plate 312 and the flat section 3225; or, the flat section 3225 is sandwiched between the second flange 3431 and the first vibrating plate 312; or, the second flange 3431 and the flat section 3225 are respectively connected to the first vibrating plate 312.

In this embodiment, as shown in FIG. 2 to FIG. 4 and FIG. 12, by providing the second flange 3431 at the inner edge of the inner connection portion 343, so that the second flange 3431 extends along the inner surface of the first vibrating plate 312. Thus, by utilizing the connection between the second flange 3431 and the first vibrating plate 312, the contact area is increased, which not only improves the connection stability, but also further improves the waterproof sealing performance. It can be understood that, by bending to form the flat section 3225 at the end of the first bent portion 3222 adjacent to the first vibrating plate 312, so that the flat section 3225 extends along the inner surface of the first vibrating plate 312. Thus, by utilizing the connection between the flat section 3225 and the first vibrating plate 312, the contact area is increased, which not only improves the connection stability, but also further improves the waterproof sealing performance.

In an embodiment, the second flange 3431 of the diaphragm 34 and the flat section 3225 of the second vibrating plate 322 are respectively connected to the first vibrating plate 312. It can be understood that both the second flange 3431 and the flat section 3225 are connected to the first vibrating plate 312. At this time, the second flange 3431 and the flat section 3225 can be spaced apart on the inner surface of the first vibrating plate 312 or provided adjacently close to each other on the inner surface of the first vibrating plate 312, which is not limited herein.

In order to reduce the area occupied on the first vibrating plate 312 when the diaphragm 34 and the second vibrating plate 322 are connected to the first vibrating plate 312, and simultaneously ensure the connection stability, the second flange 3431 of the diaphragm 34 is sandwiched between the first vibrating plate 312 and the flat section 3225 of the second vibrating plate 322, that is, the first vibrating plate 312, the second flange 3431, and the flat section 3225 are sequentially stacked along the vibration direction of the vibration system; or, the flat section 3225 of the second vibrating plate 322 is sandwiched between the second flange 3431 of the diaphragm 34 and the first vibrating plate 312, that is, the first vibrating plate 312, the flat section 3225, and the second flange 3431 are sequentially stacked along the vibration direction of the vibration system, which is not limited herein.

In an embodiment, the outer connection portion 341, the deformation portion 342, the inner connection portion 343, and the second flange 3431 of the diaphragm 34 are an integrally formed structure, such as integral injection molding or integral stamping molding, which is not limited herein.

In this embodiment, the compliance of the diaphragm 34 is optionally greater than or equal to the compliance of the folded ring portion 321. It can be understood that in this way, when the voice coil 33 drives the diaphragm 34 and the second diaphragm assembly 32 to vibrate through the first vibrating plate 312, the diaphragm 34 only plays a role of isolation and sealing, and will not produce a reverse acting force on the vibration of the second diaphragm assembly 32, improving the low-frequency sensitivity of the speaker.

It can be understood that the compliance of the diaphragm 34 is optionally greater than or equal to the compliance of the inner folded ring 311 of the first diaphragm assembly 31, and the compliance of the diaphragm 34 is optionally greater than or equal to the compliance of the outer folded ring 313 of the first diaphragm assembly 31. In this way, the diaphragm 34 only plays the role of sealing, and will not produce a reverse acting force on the vibration of the first diaphragm assembly 31 and the second diaphragm assembly 32, improving the low-frequency sensitivity.

In an embodiment, the deformation portion 342 protrudes in a direction away from the first diaphragm assembly 31, and the deformation section of the folded ring portion 321 protrudes in a direction toward the first diaphragm assembly 31. The deformation portion 342 and the deformation section of the folded ring portion 321 are staggered in a direction perpendicular to the vibration system 3. It can be understood that such a setting prevents the deformation section of the folded ring portion 321 of the second diaphragm assembly 32 from interfering with the deformation portion 342 of the diaphragm 34 during vibration. In other embodiments, the deformation section of the folded ring portion 321 can also protrude in a direction away from the first diaphragm assembly 31, which is not limited herein.

In an embodiment, along the vibration direction of the vibration system 3, the projection width L1 of the deformation portion 342 is greater than or equal to the projection width L2 of the deformation section of the folded ring portion 321, and the ratio of L1 to L2 is 1:1 to 3:1.

In this embodiment, as shown in FIG. 3, along the vibration direction of the vibration system 3, by setting the projection width L1 of the deformation portion 342 of the diaphragm 34 to be greater than or equal to the projection width L2 of the deformation section of the folded ring portion 321 of the second diaphragm assembly 32, this can effectively ensure that the effective vibration area Sd2 of the second diaphragm assembly 32 is greater than the effective vibration area Sd1 of the diaphragm 34. In this way, when the voice coil 33 drives the second diaphragm assembly 32 and the diaphragm 34 to vibrate, the diaphragm 34 plays a counteracting role in pushing the air volume, and the second diaphragm assembly 32 plays a positive role in pushing the air volume. Utilizing the volume change of the acoustic cavity 41 to increase the air volume pushed during operation, realizing an increase in the effective vibration area of the product.

In an embodiment, the ratio of L1 to L2 is 1:1, 1.5:1, 2:1, 2.5:1, 3:1, etc., which is not limited herein.

In an embodiment, the magnetic circuit system 2 includes a magnetic yoke 21, and a central magnetic portion 22 and a side magnetic portion 23 provided at the magnetic yoke 21. The side magnetic portion 23 is provided at an outer side of the central magnetic portion 22, and forms a magnetic gap 24 together with the central magnetic portion 22. An inner side of the inner folded ring 311 is connected to the central magnetic portion 22. The side magnetic portion 23 includes a plurality of side magnetic portions 23, and a clearance space 233 is formed between two adjacent side magnetic portions 23.

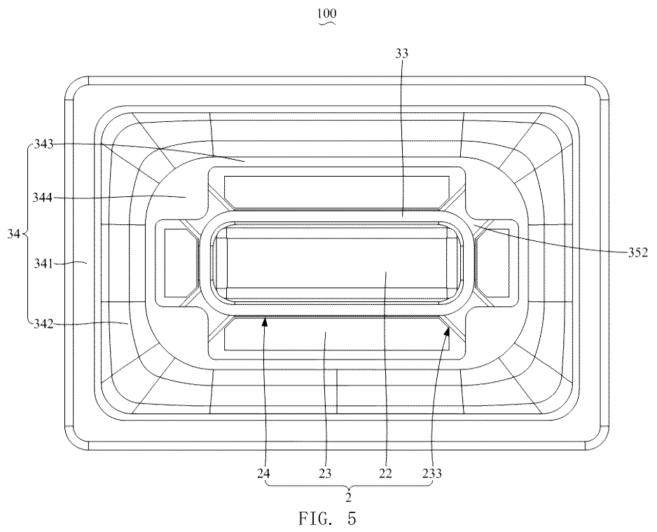

In this embodiment, as shown in FIG. 2, FIG. 5, and FIG. 6, the side magnetic portion 23 of the magnetic circuit system 2 surrounds and is provided at the outer side of the central magnetic portion 22, and the side magnetic portion 23 and the central magnetic portion 22 are spaced apart to form the magnetic gap 24. In an embodiment, the side magnetic portion 23 includes a plurality of side magnetic portions 23, and the plurality of side magnetic portions 23 are spaced apart and surround the outer side of the central magnetic portion 22, so that two adjacent side magnetic portions 23 are spaced apart to form the clearance space 233. In other embodiments, the side magnetic portion 23 can also be configured as an integral annular structure, which is not limited herein.

In an embodiment, the second vibrating plate 322 has a first extending portion 3224 extending to the clearance space 233, the diaphragm 34 has a second extending portion 344 extending to the clearance space 233, and the second extending portion 344 corresponds to and is connected to the first extending portion 3224.

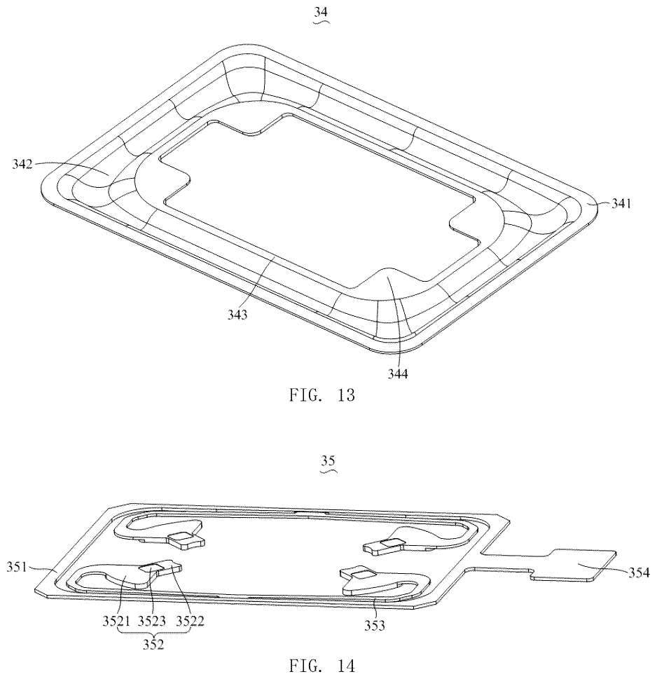

In this embodiment, as shown in FIG. 2, FIG. 5, FIG. 11, and FIG. 13, by setting a plurality of side magnetic portions 23, the plurality of side magnetic portions 23 surround and are spaced apart at the outer side of the central magnetic portion 22, so that the clearance space 233 is formed between two adjacent side magnetic portions 23, and by providing the first extending portion 3224 on the second diaphragm assembly 32, so that the first extending portion 3224 extends toward the clearance space 233, and is connected to the first diaphragm assembly 31/the first vibrating plate 312. In this way, the connection stability between the second diaphragm assembly 32 and the first diaphragm assembly 31/the first vibrating plate 312 can be increased, so as to ensure that the voice coil 33 drives the second diaphragm assembly 32 to vibrate through the first diaphragm assembly 31/the first vibrating plate 312. In an embodiment, the first extending portion 3224 is formed by extending from the second vibrating plate 322 toward the clearance space 233.

In this embodiment, as shown in FIG. 5 and FIG. 13, the diaphragm 34 has the second extending portion 344 extending to the clearance space 233. By corresponding the second extending portion 344 to the first extending portion 3224, the volume of the acoustic cavity 41 formed between the diaphragm 34 and the second vibrating plate 322 is further increased, improving the vibration effect; at the same time, the connection stability and sealing between the diaphragm 34 and the second vibrating plate 322 as well as the first diaphragm assembly 31/the first vibrating plate 312 are increased.

It can be understood that both the inner connection portion 343 and the second flange 3431 of the diaphragm 34 extend into the clearance space 233 and form the second extending portion 344, which is not limited herein. The main body portion 3221, the first bent portion 3222, and the flat section 3225 of the second vibrating plate 322 all extend into the clearance space 233 and form the first extending portion 3224, which is not limited herein.

In this embodiment, the central magnetic portion 22 is optionally a rectangular structure, the clearance space 233 of the side magnetic portion 23 is provided corresponding to a corner position of the central magnetic portion 22, the second vibrating plate 322 is provided with one first extending portion 3224 corresponding to each clearance space 233, and the diaphragm 34 is provided with one second extending portion 344 corresponding to each clearance space 233, which is not limited herein.

In another embodiment, the voice coil 33 has a first protruding portion 331 extending to the clearance space 233, the central magnetic portion 22 has a second protruding portion 224 extending to the clearance space 233, and the first protruding portion 331 is opposite to the second protruding portion 224.

In this embodiment, as shown in FIG. 6, the plurality of side magnetic portions 23 surround and are spaced apart at the outer side of the central magnetic portion 22, so that the clearance space 233 is formed between two adjacent side magnetic portions 23. By providing the first protruding portion 331 at the voice coil 33, the first protruding portion 331 extends to the clearance space 233, and the second protruding portion 224 is provided at the central magnetic portion 22, so that the second protruding portion 224 extends to the clearance space 233 and is spaced apart from and corresponds to the first protruding portion 331. Such an arrangement on one hand increases the length of the wire of the voice coil 33, facilitating the connection between the centring disk 35 and the voice coil 33, and on the other hand increases the magnet volume of the central magnetic portion 22, effectively improving the magnetic field strength and further increasing the BL value of the sound emitting device 100.

It can be understood that the central magnetic portion 22 is optionally a rectangular structure, the voice coil 33 is optionally a rectangular voice coil, the clearance space 233 of the side magnetic portion 23 is provided corresponding to the corner position of the central magnetic portion 22, the four corner positions of the voice coil 33 are respectively provided with the first protruding portions 331, and the four corner positions of the central magnetic portion 22 are respectively provided with the second protruding portions 224, which is not limited herein.

In this embodiment, the clearance space 233 of the side magnetic portion 23 has two opposite first sides, the first protruding portion 331 of the voice coil 33 has two second sides respectively opposite to the two first sides, both of the two second sides are opposite to and spaced apart from the two first sides, the second protruding portion 224 of the central magnetic portion 22 has two third sides respectively opposite to the two second sides, both of the two third sides are opposite to and spaced apart from the two second sides, that is, each second side is provided between one first side and one third side.

In an embodiment, the vibration system 3 further includes a centring disk 35. The centring disk 35 includes an outer fixing portion 351, an inner fixing portion 352, and a vibrating arm 353 connecting the outer fixing portion 351 and the inner fixing portion 352. The outer fixing portion 351 is connected to the housing 1. The second diaphragm assembly 32 includes a folded ring portion 321 and a second vibrating plate 322 which are connected. An outer peripheral edge of the folded ring portion 321 is connected to the housing 1. An inner edge of the second vibrating plate 322 is connected to the inner edge of the first diaphragm assembly 31 and/or the diaphragm 34. The inner fixing portion 352 is connected to the second vibrating plate 322 and the voice coil 33, and is electrically connected to the lead wire of the voice coil 33.

In this embodiment, as shown in FIG. 2, FIG. 6, and FIG. 14, by connecting the outer fixing portion 351 of the centring disk 35 to the housing 1, and connecting the inner fixing portion 352 to the voice coil 33, and electrically connecting to the lead wire of the voice coil 33, on one hand, the voice coil 33 is connected and conducted to an external circuit through the centring disk 35, and on the other hand, the centring disk 35 plays a centering role for the vibration of the voice coil 33, avoiding phenomena such as swinging or polarized vibration of the voice coil 33 during the vibration process.

In order to avoid interference or influence of the arrangement of the centring disk 35 on the second diaphragm assembly 32, the folded ring portion 321 of the second diaphragm assembly 32 protrudes in a direction approaching the first diaphragm assembly 31. It can be understood that the centring disk 35 can be one, or can be a plurality. When there are a plurality of centring disks 35, the plurality of centring disks 35 are correspondingly distributed along a major axis direction and/or a minor axis direction of the magnetic circuit system 2 and/or four corner positions of the magnetic circuit system 2.

It can be understood that the plurality of centring disks 35 can be symmetrically distributed along the major axis direction of the magnetic circuit system 2; the plurality of centring disks 35 can also be symmetrically distributed along the minor axis direction of the magnetic circuit system 2; the plurality of centring disks 35 can also be correspondingly provided at the four corner positions of the magnetic circuit system 2. In other embodiments, the plurality of centring disks 35 can be correspondingly distributed along the major axis direction of the magnetic circuit system 2, the minor axis direction of the magnetic circuit system 2, and diagonal or four corner positions of the magnetic circuit system 2, which is not limited herein.

In an embodiment, there are two or four centring disks 35. Such an arrangement can not only utilize the centring disks 35 to connect and conduct the voice coil 33 with the external circuit, but also ensure the vibration balance of the sound emitting device 100.

In an embodiment, the centring disk 35 includes an outer fixing portion 351, an inner fixing portion 352, and a vibrating arm 353 connecting the outer fixing portion 351 and the inner fixing portion 352. The outer fixing portion 351 is connected to the housing 1. The inner fixing portion 352 is connected to the second vibrating plate 322 and the voice coil 33.

In this embodiment, as shown in FIG. 2 to FIG. 4 and FIG. 14, the inner fixing portion 352 is connected to the second vibrating plate 322 of the second diaphragm assembly 32 and the voice coil 33, and is electrically connected to the lead wire of the voice coil 33. In an embodiment, the inner fixing portion 352 is provided with an inner soldering pad 3523, and the lead wire of the voice coil 33 is connected and conducted to the inner soldering pad 3523. In this way, the routing and connection of the lead wire of the voice coil 33 can be easily achieved, and connection and conduction with the external circuit can be smoothly achieved. It can be understood that the main body portion 3221 of the second vibrating plate 322 is connected to the inner fixing portion 352 of the centring disk 35. In an embodiment, the inner fixing portion 352 is connected to a side of the main body portion 3221 facing away from the folded ring portion 321.

In an embodiment, as shown in FIG. 2 and FIG. 14, the outer fixing portion 351, the vibrating arm 353, and the inner fixing portion 352 of the centring disk 35 can be an integrally formed structure. This can effectively ensure the structural strength of the centring disk 35, and simultaneously simplify the processing steps of the centring disk 35. In order to ensure the deformation capability of the centring disk 35, In an embodiment, the vibrating arm 353 has at least one bend.

In an embodiment, as shown in FIG. 2 and FIG. 14, the outer fixing portion 351 is annularly provided, the outer fixing portion 351 has short axis sides and long axis sides alternately connected, the vibrating arm 353 leads out from a side of the inner fixing portion 352 corresponding to the short axis side, bends, and then extends along the long axis side, and the vibrating arm 353 is connected to a central region of the long axis side.

In this embodiment, as shown in FIG. 2 and FIG. 14, there is one centring disk 35. At this time, the outer fixing portion 351 of the centring disk 35 is optionally a rectangular ring structure, the vibrating arm 353 includes at least two, and there are optionally four inner fixing portions 352. It can be understood that such an arrangement can increase the length of the vibrating arm 353 and improve the stress of the vibrating arm 353, thereby improving reliability.

In an embodiment, the vibrating arm 353 includes four, and the inner fixing portion 352 includes four. Each inner fixing portion 352 is connected to the outer fixing portion 351 through one vibrating arm 353. In an embodiment, the four vibrating arms 353 and the four inner fixing portions 352 are respectively provided corresponding to four corner positions of the rectangular ring outer fixing portion 351. In this embodiment, the four inner fixing portions 352 are respectively provided corresponding to the clearance spaces 233 of the side magnetic portions 23, and at least a part of the inner fixing portion 352 passes through the clearance space 233 and extends into the magnetic gap 24, and is connected to the voice coil 33, which is not limited herein.

It can be understood that, as shown in FIG. 2 and FIG. 14, the outer fixing portion 351, the vibrating arm 353, and the inner fixing portion 352 of the centring disk 35 can be provided in the same plane. In other embodiments, the outer fixing portion 351 and the inner fixing portion 352 of the centring disk 35 can also be provided in different planes, which is not limited herein.

In this embodiment, as shown in FIG. 2 to FIG. 4 and FIG. 14, the voice coil 33 optionally presents a rectangular ring shape, and the four inner fixing portions 352 of the centring disk 35 are respectively provided corresponding to the four corner positions of the voice coil 33, which is not limited herein. It can be understood that the outer fixing portion 351 of the centring disk 35 is bonded and connected to the housing 1, and the inner fixing portion 352 and the second vibrating plate 322 and the voice coil 33 can be connected by bonding or welding, which is not limited herein. In this way, the outer dimension length of the product can be utilized to increase the length of the vibrating arm 353 of the centring disk 35, resulting in better reliability during large-amplitude operation; at the same time, the centring disk 35 provides constraints on the vibration system 3, which can better suppress poor performance caused by polarized vibration of the product under large amplitude.

In order to better connect with external circuits, in an embodiment, as shown in FIG. 1, FIG. 2, FIG. 4, FIG. 6, and FIG. 14, the centring disk 35 further includes a conductive portion 354, a first end of the conductive portion 354 is connected to the outer fixing portion 351, a second end of the conductive portion 354 extends in a direction away from the housing 1, and is provided with an external soldering pad. Such an arrangement can guide the external soldering pad to the outside of the housing 1 through the conductive portion 354, thereby facilitating connection and conduction between the external circuit and the centring disk 35, ensuring current is passed into the voice coil 33.

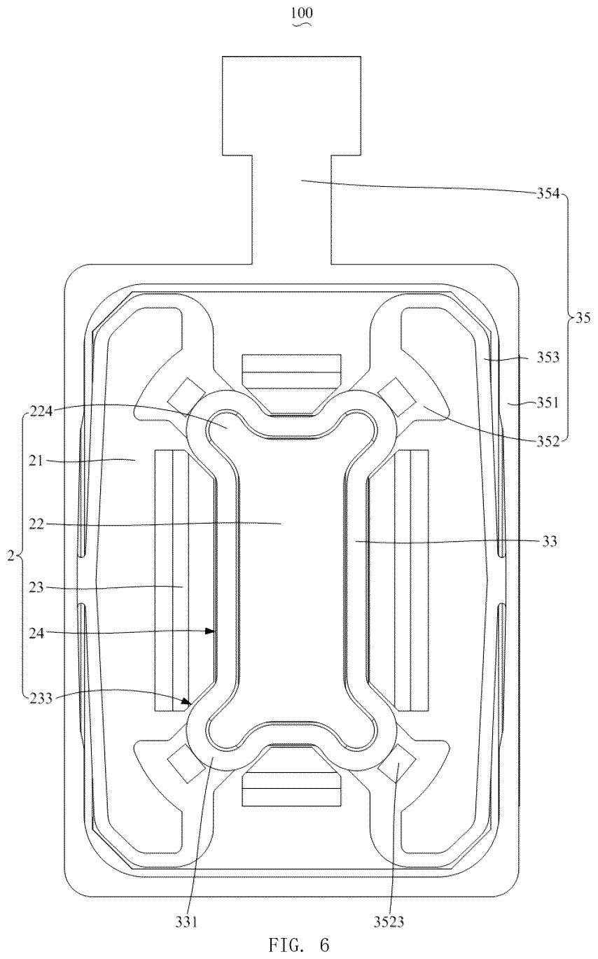

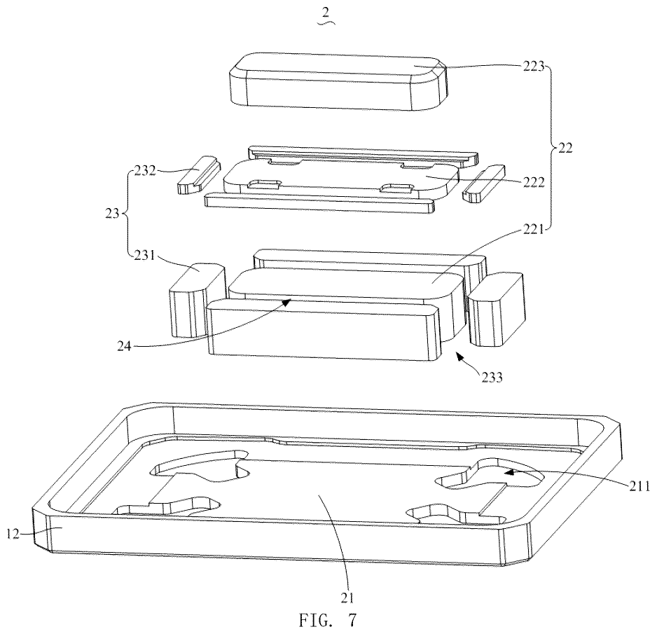

In an embodiment, the magnetic yoke 21 is provided with a clearance structure 211 corresponding to the inner fixing portion 352. It can be understood that, as shown in FIG. 2 and FIG. 7, by providing the clearance structure 211 at the magnetic yoke 21, the clearance structure 211 can be utilized to provide clearance for the centring disk 35 during the vibration with the second diaphragm assembly 32, ensuring that the inner fixing portion 352 of the centring disk 35 will not touch the magnetic yoke 21.

In an embodiment, the clearance structure 211 is a recessed groove or a through hole. It can be understood that the clearance structure 211 is a recessed groove, that is, a groove structure formed by recessing a side of the magnetic yoke 21 facing the centring disk 35 in a direction away from the centring disk 35. The clearance structure 211 is a through hole, that is, the through hole penetrates the magnetic yoke 21; at the same time, the clearance structure 211 can also be configured as a vent hole of the sound emitting device 100 to ensure that the airflow of the vibration cavity of the sound emitting device 100 is in communication with the external airflow during the vibration process of the first diaphragm assembly 31, thereby ensuring internal and external air pressure balance.

In an embodiment, the inner fixing portion 352 includes a body portion 3521 and a third extending portion 3522 extending from the body portion 3521 toward the voice coil 33. The body portion 3521 is connected to the second vibrating plate 322, and the third extending portion 3522 is connected to the voice coil 33. The third extending portion 3522 or the body portion 3521 is provided with an inner soldering pad 3523 electrically connected to the lead wire of the voice coil 33.

In this embodiment, as shown in FIG. 2 and FIG. 14, by setting the inner fixing portion 352 of the centring disk 35 as the body portion 3521 and the third extending portion 3522, so that the third extending portion 3522 extends toward the voice coil 33, in this way, while utilizing the body portion 3521 of the inner fixing portion 352 to connect to the second vibrating plate 322 of the second diaphragm assembly 32, the inner fixing portion 352 of the centring disk 35 is connected to the voice coil 33 through the third extending portion 3522, further ensuring that the voice coil 33 drives the second diaphragm assembly 32 to vibrate during the vibration process.

It can be understood that by providing the inner soldering pad 3523 at the third extending portion 3522 or the body portion 3521, it is convenient to utilize the inner soldering pad 3523 to electrically connect with the lead wire of the voice coil 33, thereby ensuring that the voice coil 33 achieves connection and conduction with the external circuit through the centring disk 35.

In an embodiment, the side magnetic portion 23 includes a plurality of side magnetic portions 23, the clearance space 233 is formed between two adjacent side magnetic portions 23, the voice coil 33 has a first protruding portion 331 extending to the clearance space 233, and the first protruding portion 331 is connected to the inner fixing portion 352.

In this embodiment, as shown in FIG. 6, by providing the first protruding portion 331 at the voice coil 33, so that the first protruding portion 331 extends to the clearance space 233, this not only can increase the length of the wire of the voice coil 33, thereby helping to improve the BL value, but also facilitates the connection between the centring disk 35 and the voice coil 33. It can be understood that the central magnetic portion 22 has a second protruding portion 224 extending to the clearance space 233, and the first protruding portion 331 is opposite to the second protruding portion 224. In this way, the magnet volume of the central magnetic portion 22 can be increased, thereby effectively improving the magnetic field strength, and the BL value of the sound emitting device 100 can be further improved.

It can be understood that by connecting the inner fixing portion 352 of the centring disk 35 to the first protruding portion 331 of the voice coil 33, on one hand, the voice coil 33 is connected and conducted to the external circuit through the centring disk 35, and on the other hand, the centring disk 35 plays a centering role for the vibration of the voice coil 33, avoiding phenomena such as swinging or polarized vibration of the voice coil 33 during the vibration process.

In an embodiment, the housing 1 includes a first housing 11 and a second housing 12, the first housing 11 is provided with a sound output hole 111, the outer peripheral edge of the outer folded ring 313 and the outer peripheral edge of the diaphragm 34 are both connected to the first housing 11, the magnetic circuit system 2 is connected to the second housing 12, and the outer peripheral edge of the second diaphragm assembly 32 is sandwiched between the first housing 11 and the second housing 12.

In this embodiment, as shown in FIG. 1 to FIG. 4, by setting the housing 1 as the first housing 11 and the second housing 12, it is convenient to utilize the first housing 11 to achieve fixing and mounting for the outer peripheral edges of the first diaphragm assembly 31 and the diaphragm 34, and utilize the second housing 12 to achieve mounting and fixing of the magnetic circuit system 2, while utilizing the first housing 11 and the second housing 12 to achieve mounting and fixing of the outer peripheral edge of the second diaphragm assembly 32.

It can be understood that the outer peripheral edge of the outer folded ring 313 of the first diaphragm assembly 31 and the outer peripheral edge of the diaphragm 34 are both connected to the first housing 11, the magnetic yoke 21 of the magnetic circuit system 2 is connected to the second housing 12, and the outer peripheral edge of the second diaphragm assembly 32 is sandwiched between the first housing 11 and the second housing 12.

In an embodiment, as shown in FIG. 2 to FIG. 4, FIG. 6, and FIG. 14, the vibration system 3 further includes a centring disk 35, the centring disk 35 includes an outer fixing portion 351, an inner fixing portion 352, and a vibrating arm 353 connecting the outer fixing portion 351 and the inner fixing portion 352, the outer fixing portion 351 is sandwiched between the second housing 12 and the outer peripheral edge of the second diaphragm assembly 32, the inner fixing portion 352 is connected to the voice coil 33, and is electrically connected to the lead wire of the voice coil 33.

In this embodiment, the housing 1 can be a plastic housing or a metal housing, that is, both the first housing 11 and the second housing 12 can be plastic housings or metal housings. In other embodiments, one of the first housing 11 and the second housing 12 of the housing 1 is a plastic housing, and the other is a metal housing, etc., which is not limited herein.

In an embodiment, the second housing 12 of the housing 1 and the magnetic yoke 21 of the magnetic circuit system 2 are an integrally formed structure. It can be understood that when the second housing 12 is a plastic housing, the second housing 12 and the magnetic yoke 21 are integrally injection-molded. Alternatively, when the second housing 12 is a metal housing, the second housing 12 and the magnetic yoke 21 are an integrally formed structure, which is not limited herein.

In an embodiment, the first housing 11 is optionally a metal housing, and the second housing 12 is optionally a metal housing.

In order to further improve the connection stability of the first housing 11 and the second housing 12 or the magnetic circuit system 2, in an embodiment, as shown in FIG. 1 and FIG. 2, the first housing 11 is provided with a welding portion 121 extending toward the magnetic circuit system 2. The welding portion 121 is welded and connected to the magnetic circuit system 2 or the second housing 12, that is, the first housing 11 is provided with the welding portion 121 extending toward the magnetic yoke 21. The welding portion 121 is welded and connected to the magnetic yoke 21 or the second housing 12. In another embodiment, as shown in FIG. 1 and FIG. 2, the magnetic circuit system 2 or the second housing 12 is provided with a welding portion 121 extending toward the first housing 11. The welding portion 121 is welded and connected to the outer wall of the first housing 11, that is, the magnetic yoke 21 or the second housing 12 is provided with the welding portion 121 extending toward the first housing 11. The welding portion 121 is welded and connected to the outer wall of the first housing 11.

In an embodiment, in yet another embodiment, the sound emitting device 100 further includes a metal soldering piece, a first end of the metal soldering piece is welded and connected to the magnetic circuit system 2 or the second housing 12, and a second end of the metal soldering piece is welded and connected to the outer wall of the first housing 11, that is, the first end of the metal soldering piece is welded and connected to the magnetic yoke 21 or the second housing 12, and the second end of the metal soldering piece is welded and connected to the outer wall of the first housing 11. It can be understood that in this way, the connection stability between the first housing 11 and the second housing 12 or the magnetic yoke 21 can be further improved through the metal soldering piece.

In an embodiment, the first housing 11 has a side wall 112 and an inner bent portion 113 formed by an end of the side wall 112 away from the second housing 12 bending and extending inward. The outer peripheral edge of the outer folded ring 313 and the outer peripheral edge of the diaphragm 34 are both connected to the inner bent portion 113. The outer peripheral edge of the second diaphragm assembly 32 is sandwiched between an end of the side wall 112 away from the inner bent portion 113 and the second housing 12. The sound output hole 111 is provided at the side wall 112 or the inner bent portion 113.

In this embodiment, as shown in FIG. 2 to FIG. 4, by configuring the first housing 11 as the side wall 112 and the inner bent portion 113 provided at an angle, the inner bent portion 113 of the first housing 11 is utilized to achieve mounting and fixing of the first diaphragm assembly 31 and the diaphragm 34, and at the same time, the side wall 112 of the first housing 11 cooperates with the second housing 12 to clamp and fix the outer peripheral edges of the second diaphragm assembly 32 and the centring disk 35, that is, the outer peripheral edge of the folded ring portion 321 of the second diaphragm assembly 32 and the outer fixing portion 351 of the centring disk 35 are sandwiched between the end of the side wall 112 away from the inner bent portion 113 and the second housing 12.

It can be understood that the outer fixing portion 351 of the centring disk 35 is provided between the outer peripheral edge of the folded ring portion 321 of the second diaphragm assembly 32 and the second housing 12, and the other end of the second housing 12 is connected to the magnetic yoke 21. In this embodiment, the inner bent portion 113 of the first housing 11 is formed by bending and extending inward from the end of the side wall 112 away from the second housing 12, that is, the inner bent portion 113 and the side wall 112 of the first housing 11 are an integrally formed structure, which can ensure the structural strength of the first housing 11, and is not limited herein.

In order to further increase the contact area between the first diaphragm assembly 31 and the first housing 11, and improve the connection stability and waterproof sealing performance, the outer peripheral edge of the outer folded ring 313 of the first diaphragm assembly 31 bends and extends to form a third flange 3131, and the third flange 3131 is connected to an outer wall surface of the side wall 112 of the first housing 11.

In this embodiment, the outer folded ring 313 of the first diaphragm assembly 31 is fixed to the inner bent portion 113 of the first housing 11, so that the first diaphragm assembly 31 is bonded and fixed to a maximum outer profile of the housing 1. In this way, the outer dimension of the product can be utilized to increase the effective vibration area of the product. At the same time, the magnetic yoke 21 of the magnetic circuit system 2 is fixed to the second housing 12, and the outer peripheral edge of the second diaphragm assembly 32 is sandwiched between the first housing 11 and the second housing 12. The height of the housing 1 can be correspondingly adjusted to increase or decrease according to the requirements of the product amplitude, so that the acoustic cavity 41 between the diaphragm 34 and the second diaphragm assembly 32 adapts to the needs of different products.

In an embodiment, the sound output hole 111 is provided at the side wall 112 or the inner bent portion 113, which is not limited herein.

In an embodiment, as shown in FIG. 3 and FIG. 4, the inner bent portion 113 includes an upper surface, a lower surface, and an inner side surface. The upper surface and the lower surface are provided facing away from each other. The inner side surface connects the upper surface and the lower surface, and is provided at an end of the inner bent portion 113 away from the side wall 112.

In this embodiment, as shown in FIG. 3 and FIG. 4, the outer peripheral edge of the outer folded ring 313 is connected to the upper surface, and the outer peripheral edge of the diaphragm 34 is connected to the lower surface. Such an arrangement can not only achieve the fixation of the first diaphragm assembly 31 and the diaphragm 34, but also ensure the distance between the first diaphragm assembly 31 and the diaphragm 34, thereby avoiding problems such as interference during the vibration process.

In other embodiments, the outer peripheral edge of the outer folded ring 313 of the first diaphragm assembly 31 is connected to the upper surface, and the outer peripheral edge of the diaphragm 34 is connected to the inner side surface; or, the outer peripheral edge of the outer folded ring 313 is connected to the upper surface, and the outer peripheral edge of the diaphragm 34 is sandwiched between the outer peripheral edge of the outer folded ring 313 and the upper surface; or, the outer peripheral edge of the outer folded ring 313 is connected to the inner side surface, and the outer peripheral edge of the diaphragm 34 is connected to the lower surface; or, the outer peripheral edges of the outer folded ring 313 and the diaphragm 34 are both connected to the inner side surface, which is not limited herein.

It can be understood that the outer connection portion 341 of the diaphragm 34 can be connected to the lower surface or the inner side surface or the upper surface of the inner bent portion 113, etc., which is not limited herein. In this embodiment, when the outer connection portion 341 of the diaphragm 34 and the outer peripheral edge of the outer folded ring 313 are connected to the upper surface of the inner bent portion 113 at the same time, the outer connection portion 341 of the diaphragm 34 is provided between the outer peripheral edge of the outer folded ring 313 and the upper surface of the inner bent portion 113, which is not limited herein.

In an embodiment, the central magnetic portion 22 includes a first central magnet 221, a central pole plate 222, and a second central magnet 223 which are stacked. The first central magnet 221 is connected to the magnetic yoke 21, and the inner side of the inner folded ring 311 is connected to the second central magnet 223.

In this embodiment, as shown in FIG. 2 to FIG. 4 and FIG. 7, by configuring the central magnetic portion 22 as a counter-magnetic structure, the first central magnet 221, the central pole plate 222, and the second central magnet 223 are stacked at the magnetic yoke 21 in sequence along the vertical direction. It can be understood that both the first central magnet 221 and the second central magnet 223 are magnetized along the vibration direction of the vibration system 3, and the magnetization direction of the first central magnet 221 is opposite to the magnetization direction of the second central magnet 223. In this way, utilizing the magnetic conduction effect of the central pole plate 222, the magnetic lines of force of the first central magnet 221 and the second central magnet 223 are gathered at the central pole plate 222, and transmitted to the magnetic gap 24 by the central pole plate 222. Thus, the central magnetic portion 22 generates a magnetic field with a strong magnetic field strength passing through the magnetic gap 24, thereby increasing the density of the magnetic flux of the magnetic gap 24, increasing the number of magnetic lines of force passing through the voice coil 33, increasing the magnetic force received by the voice coil 33, and effectively improving the BL value.

In an embodiment, the first central magnet 221 is an integral plate-shaped structure. In this embodiment, as shown in FIG. 2 to FIG. 4 and FIG. 7, by configuring the first central magnet 221 as an integral plate-shaped structure, it not only facilitates the processing of the first central magnet 221, but also facilitates assembly and magnetization, effectively improving production and assembly efficiency.

In other embodiments, the first central magnet 221 includes a plurality of first central magnets 221. The plurality of first central magnets 221 are adjacent to each other and laid flat between the central pole plate 222 and the magnetic yoke 21. The plurality of first central magnets 221 are all magnetized along the vibration direction of the vibration system 3, and the magnetization directions of the plurality of first central magnets 221 are the same. In an embodiment, the magnetic poles of the plurality of first central magnets 221 on a side approaching the central pole plate 222 are all the same.

In an embodiment, the central pole plate 222 of the central magnetic portion 22 can be an integral square plate-shaped structure and provided between the first central magnet 221 and the second central magnet 223; or, the central pole plate 222 includes a plurality of central pole plates 222, and the plurality of central pole plates 222 are provided adjacent to each other and in parallel between the first central magnet 221 and the second central magnet 223, so that the plurality of central pole plates 222 cooperate to form a square plate-shaped structure, which is not limited herein.

In an embodiment, the second central magnet 223 is an integral plate-shaped structure. In this embodiment, as shown in FIG. 2 to FIG. 4 and FIG. 7, by configuring the second central magnet 223 as an integral plate-shaped structure, it not only facilitates the processing of the second central magnet 223, but also facilitates assembly and magnetization, effectively improving production and assembly efficiency.

In other embodiments, the second central magnet 223 includes a plurality of second central magnets 223. The plurality of second central magnets 223 are adjacent to each other and laid flat on a side of the central pole plate 222 facing away from the first central magnet 221. The plurality of second central magnets 223 are all magnetized along the vibration direction of the vibration system 3, and the magnetization directions of the plurality of second central magnets 223 are the same. In an embodiment, the magnetic poles of the plurality of second central magnets 223 on a side approaching the central pole plate 222 are all the same.

In this embodiment, the inner side of the inner folded ring 311 of t first diaphragm assembly 31 is connected to the second central magnet 223. In order to avoid interference of the second central magnet 223 on the inner folded ring 311 when the inner folded ring 311 vibrates, in an embodiment, as shown in FIG. 2 to FIG. 4 and FIG. 7, an edge of the second central magnet 223 is provided with a clearance structure.

In this embodiment, the clearance structure is annularly provided at a peripheral edge of a side of the second central magnet 223 facing away from the central pole plate 222, that is, the clearance structure is an integral annular inclined surface. In other embodiments, the clearance structure includes a plurality of clearance structures. The plurality of clearance structures are spaced apart and annularly provided at the peripheral edge of the side of the second central magnet 223 facing away from the central pole plate 222. At this time, two adjacent clearance structures are not connected to each other, and also have a certain spacing. Alternatively, the clearance structure includes a plurality of clearance structures, and adjacent clearance structures are connected end to end to form a closed annular structure, and annularly provided at the peripheral edge of the side of the second central magnet 223 facing away from the central pole plate 222. At this time, adjacent clearance structures among the plurality of clearance structures are adjacent and form an annular structure. In an embodiment, included angles respectively formed by the plurality of clearance structures and a surface of the side of the second central magnet 223 facing away from the central pole plate 222 can be the same, can be different, or can be at least partially the same, which is not limited herein.

In an embodiment, the clearance structure is optionally at least one of an inclined slope, a rounded corner, a chamfer, and a stepped structure.

In an embodiment, an included angle formed by the clearance structure and a surface of a side of the second central magnet 223 facing away from the central pole plate 222 is greater than 90° and less than 180°. In this embodiment, a range of the included angle formed by the clearance structure and the surface of the side of the second central magnet 223 facing away from the central pole plate 222 is further optionally 100° to 150°, which is not limited herein. In an embodiment, the included angle is 100°, 110°, 120°, 130°, 140°, 150°, etc., which is not limited herein.

In an embodiment, the side magnetic portion 23 includes a side magnet 231 and a side pole plate 232 which are stacked. The side magnet 231 is connected to the magnetic yoke 21. The side pole plate 232 is opposite to the central pole plate 222. The side magnet 231 is magnetized along the vibration direction of the vibration system 3. A magnetization direction of the side magnet 231 is opposite to the magnetization direction of the first central magnet 221.

It can be understood that, as shown in FIG. 2 to FIG. 4 and FIG. 7, side magnet 231 and the side pole plate 232 of the side magnetic portion 23 are stacked at the magnetic yoke 21, and the side magnet 231 is connected to the magnetic yoke 21. The side magnet 231 and the side pole plate 232 of the side magnetic portion 23 are provided at the outer side of the central magnetic portion 22, and are spaced apart to form the magnetic gap 24. In this embodiment, the side magnet 231 is optionally a permanent magnet, and the side pole plate 232 is optionally a pole plate structure, which is not limited herein.

In this embodiment, the side magnetic portion 23 includes a plurality of side magnetic portions 23. The plurality of side magnetic portions 23 are annularly provided at the outer side of the central magnetic portion 22, and are spaced apart from and enclose the central magnetic portion 22 to form the magnetic gap 24. At this time, the clearance space 233 is formed by spacing between adjacent side magnetic portions 23, so that the clearance space 233 is utilized to provide a mounting clearance space and a moving space for the first vibrating plate 312 and the inner fixing portion 352 of the centring disk 35. In an embodiment, there are a plurality of side magnets 231 and a plurality of side pole plates 232, and they are provided in a one-to-one correspondence.

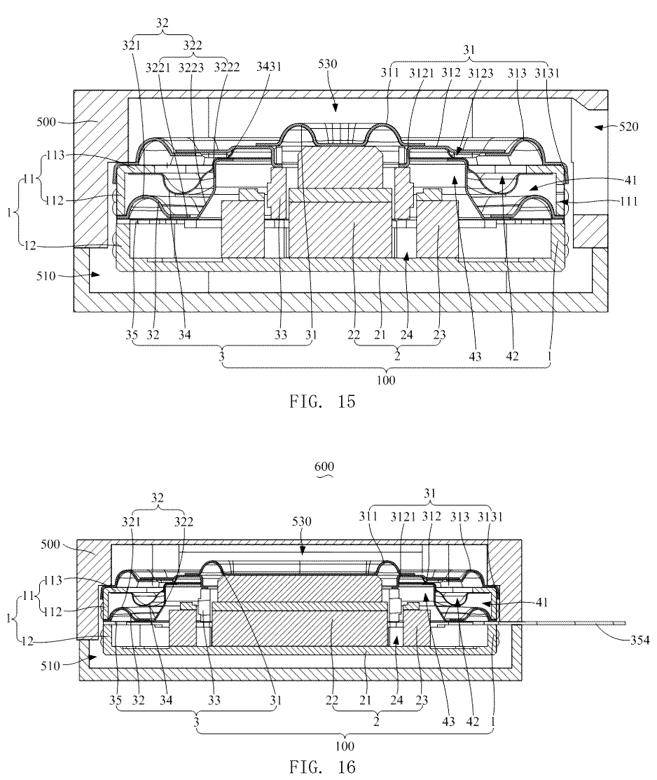

As shown in FIG. 15 and FIG. 16, the present application further provides a sound emitting module 600. The sound emitting module 600 includes the above sound emitting device 100. The specific structure of the sound emitting device 100 refers to the foregoing embodiments. Since the sound emitting module 600 adopts all the technical solutions of all the foregoing embodiments, it at least has all the beneficial effects brought about by the technical solutions of the foregoing embodiments, which will not be repeated herein one by one.

In an embodiment, the sound emitting module 600 further includes module housing 500. The module housing 500 is provided with a mounting cavity 510 and a sound output port 520 communicating with the mounting cavity 510. The sound emitting device 100 is provided at the mounting cavity 510. A front acoustic cavity 530 is formed between the first diaphragm assembly 31 of the sound emitting device 100 and the module housing 500. The front acoustic cavity 530 is in communication with the sound output port 520. The acoustic cavity 41 of the sound emitting device 100 is in communication with the sound output port 520 through the front acoustic cavity 530; or, the module housing 500 is further provided with a sound output channel, and the acoustic cavity 41 of the sound emitting device 100 is in communication with the sound output port 520 through the sound output channel; or, the sound output hole 111 of the sound emitting device 100 faces and is in communication with the sound output port 520.

In this embodiment, the sound emitting module 600 can be a front sound output structure or a side sound output structure. When the sound emitting module 600 is the front sound output structure, the sound output port 520 of the module housing 500 and the first diaphragm assembly 31 of the sound emitting device 100 are provided facing each other. It can be understood that the sound output hole 111 on the housing 1 of the sound emitting device 100 is provided at the inner bent portion 113 of the first housing 11. The sound output hole 111 and the sound output port 520 of the module housing 500 are provided facing each other. At this time, the sound output hole 111 is in communication with the front acoustic cavity 530; or, the sound output hole 111 is in communication with the sound output port 520 through the sound output channel of the module housing 500, which is not limited herein.

In an embodiment, the sound output hole 111 on the housing 1 can also be provided at the side wall 112 of the first housing 11, and the sound output hole 111 is in communication with the sound output port 520 through the sound output channel of the module housing 500, which is not limited herein.

It can be understood that when the sound emitting module 600 is a side sound output structure, the sound output port 520 of the module housing 500 is provided at one side of the first diaphragm assembly 31 of the sound emitting device 100. It can be understood that the sound output hole 111 on the housing 1 of the sound emitting device 100 is provided at the inner bent portion 113 of the first housing 11. At this time, the sound output hole 111 can communicate with the sound output port 520 through the sound output channel of the module housing 500, which is not limited herein.

In an embodiment, the sound output hole 111 on the housing 1 can also be provided at the side wall 112 of the first housing 11. At this time, the sound output hole 111 is in communication with the sound output port 520 through the sound output channel of the module housing 500; or, the sound output hole 111 and the sound output port 520 of the module housing 500 are provided to face each other and communicate with each other, which is not limited herein.

In an embodiment, the sound emitting module 600 further includes flexible circuit board. One end of the flexible circuit board is electrically connected to the centring disk 35 of the sound emitting device 100, and the other end of the flexible circuit board is configured to connect to an external power source.

It can be understood that the flexible circuit board is configured to connect and conduct the external circuit with the sound emitting device 100. The flexible circuit board is provided with an inner soldering pad and an outer soldering pad. The inner soldering pad of the flexible circuit board is connected and conducted with the external soldering pad of the centring disk 35 of the sound emitting device 100. The outer soldering pad of the flexible circuit board is configured to connect with an external terminal.

In this embodiment, the module housing 500 has the mounting cavity 510, the sound emitting device 100 is provided in the mounting cavity 510 of the module housing 500, and at least one end of the flexible circuit board connected to the sound emitting device 100 is provided in the mounting cavity 510 of the module housing 500. In other embodiments, the flexible circuit board can also be entirely provided in the mounting cavity 510 of the module housing 500, which is not limited herein.

The present application further provides an electronic device. The electronic device includes the above sound emitting device 100. The specific structure of the sound emitting device 100 refers to the foregoing embodiments. Since the electronic device adopts all the technical solutions of all the foregoing embodiments, it at least has all the beneficial effects brought about by the technical solutions of the foregoing embodiments, which will not be repeated herein one by one.

In this embodiment, the electronic device further includes a device housing, and both the sound emitting device 100 and the flexible circuit board are provided in the device housing. It can be understood that the electronic device can be an earphone, a mobile phone, a smart wearable device, etc., which is not limited herein.

The present application further provides an electronic device. The electronic device includes the above sound emitting module 600. The specific structure of the sound emitting module 600 refers to the foregoing embodiments. Since the electronic device adopts all the technical solutions of all the foregoing embodiments, it at least has all the beneficial effects brought about by the technical solutions of the foregoing embodiments, which will not be repeated herein one by one.

It can be understood that the electronic device can be an earphone, mobile phone, a smart wearable device, etc., which is not limited herein. In this embodiment, the electronic device further includes a device housing, and the sound emitting module 600 is provided in the device housing.

The above are only optional embodiments of the present application, and do not limit the patent scope of the present application. Under the concept of the present application, equivalent structural transformations made by using the contents of the specification and the drawings of the present application, or direct/indirect applications in other related technical fields are all included in the patent protection scope of the present application.

What is claimed is:

1. A sound emitting device, comprising:
a housing provided with a sound output hole;
a magnetic circuit system connected to the housing and provided with a magnetic gap; and
a vibration system comprising a first diaphragm assembly, a second diaphragm assembly, a voice coil, and a diaphragm, wherein:
the first diaphragm assembly comprises an inner folded ring, a first vibrating plate, and an outer folded ring connected in sequence;
an inner side of the inner folded ring is connected to the magnetic circuit system;
an outer peripheral edge of the outer folded ring is connected to the housing;
a first end of the voice coil is connected to the first vibrating plate, and a second end of the voice coil is suspended in the magnetic gap;
the diaphragm and the second diaphragm assembly are sequentially provided at a side of the first diaphragm assembly facing the voice coil and are provided at an outer side of the voice coil;
an outer edge of the diaphragm and an outer edge of the second diaphragm assembly are connected to the housing; and
an inner edge of the diaphragm and an inner edge of the second diaphragm assembly are connected to the first diaphragm assembly, to form an acoustic cavity communicating with the sound output hole between the diaphragm and the second diaphragm assembly.

2. The sound emitting device according to claim 1, wherein the second diaphragm assembly comprises a folded ring portion and a second vibrating plate, an outer peripheral edge of the folded ring portion is connected to the housing, the second vibrating plate comprises a main body portion connected to an inner edge of the folded ring portion and a first bent portion extending in a bending manner from the main body portion toward the first diaphragm assembly, and the first bent portion is connected to at least one of the first diaphragm assembly and the inner edge of the diaphragm.

3. The sound emitting device according to claim 2, wherein:
an inclined portion is formed at a connection between the main body portion and the first bent portion, and the inclined portion is provided at an angle with respect to a vibration direction of the vibration system; and/or
an outer peripheral edge of the folded ring portion is bent to form a first flange, and the first flange is connected to an outer wall of the housing.

4. The sound emitting device according to claim 2, wherein:
the magnetic circuit system comprises a magnetic yoke, a central magnetic portion provided at the magnetic yoke and a side magnetic portion provided at the magnetic yoke;
the side magnetic portion is provided at an outer side of the central magnetic portion, and forms the magnetic gap together with the central magnetic portion;
the inner side of the inner folded ring is connected to the central magnetic portion;
the side magnetic portion comprises a plurality of side magnetic portions, and a clearance space is formed between two adjacent side magnetic portions;
the second vibrating plate has a first extending portion extending to the clearance space;
the diaphragm has a second extending portion extending to the clearance space, and the second extending portion corresponds to and is connected to the first extending portion; or
the voice coil has a first protruding portion extending to the clearance space, the central magnetic portion has a second protruding portion extending to the clearance space, and the first protruding portion is opposite to the second protruding portion.

5. The sound emitting device according to claim 2, wherein:
the diaphragm is a flexible element;
the diaphragm comprises an outer connection portion, a deformation portion, and an inner connection portion connected in sequence;
an outer peripheral edge of the outer connection portion is connected to the housing;
an inner edge of the inner connection portion is connected to at least one of the first diaphragm assembly and the first bent portion; and
the deformation portion is in a bent shape.

6. The sound emitting device according to claim 5, wherein:
an inner edge of the inner connection portion extends along an inner surface of the first diaphragm assembly to form a second flange, and an end of the first bent portion adjacent to the first diaphragm assembly forms a flat section extending along the inner surface of the first diaphragm assembly; and
the second flange is sandwiched between the first diaphragm assembly and the flat section; or, the flat section is sandwiched between the second flange and the first diaphragm assembly; or, the second flange is connected to the first diaphragm assembly, and the flat section is connected to the first diaphragm assembly.

7. The sound emitting device according to claim 5, wherein:
a projection width L1 of the deformation portion along a vibration direction of the vibration system is greater than or equal to a projection width L2 of a deformation section of the folded ring portion, and a ratio of L1 to L2 is 1:1 to 3:1; and/or
the deformation portion protrudes in a direction away from the first diaphragm assembly, the deformation section of the folded ring portion protrudes in a direction toward the first diaphragm assembly, and the deformation portion and the deformation section of the folded ring portion are staggered in a direction perpendicular to the vibration system; and/or
both the inner folded ring and the outer folded ring protrude in a direction away from the magnetic circuit system; and/or
a compliance of the diaphragm is greater than or equal to a compliance of the folded ring portion.

8. The sound emitting device according to claim 1, wherein an effective vibration area Sd1 of the diaphragm is smaller than an effective vibration area Sd2 of the second diaphragm assembly, and a ratio of Sd1 to Sd2 is 1:1.5 to 1:3.

9. The sound emitting device according to claim 1, wherein the first vibrating plate bends and extends toward the voice coil to form a second bent portion, and the second bent portion is connected to the voice coil; or, the first diaphragm assembly further comprises a first bracket, a first end of the first bracket is connected to the first vibrating plate, and a second end of the first bracket is connected to the voice coil; and/or
the inner edge of the diaphragm is connected to the first vibrating plate, and the inner edge of the second diaphragm assembly is connected to the first vibrating plate; the first vibrating plate is provided with a protruding portion approaching the diaphragm; the inner edge of the diaphragm is connected to the protruding portion, and the inner edge of the second diaphragm assembly is connected to the protruding portion; or, the first diaphragm assembly further comprises a second bracket; a first end of the second bracket is connected to the first vibrating plate; a second end of the second bracket is connected to the inner edge of the diaphragm, and the second end of the second bracket is connected to the inner edge of the second diaphragm assembly; and/or
an outer peripheral edge of the outer folded ring is bent and extends to form a third flange, and the third flange is connected to an outer wall of the housing.

10. The sound emitting device according to claim 1, wherein:
a first rear cavity is enclosed between the first diaphragm assembly and the diaphragm;
a second rear cavity is enclosed among the first diaphragm assembly, the second diaphragm assembly, the housing, and the magnetic circuit system;
the first vibrating plate is provided with a protruding portion approaching the diaphragm; the inner edge of the diaphragm and the inner edge of the second diaphragm assembly are both connected to the protruding portion; and
the protruding portion is provided with an airflow channel communicating the first rear cavity with the second rear cavity.

11. The sound emitting device according to claim 10, wherein:
the airflow channel comprises a plurality of airflow channels spaced apart along the protruding portion; and/or
the first vibrating plate extends in a bending manner toward the voice coil to form a second bent portion, the second bent portion is connected to the voice coil, and the second bent portion is provided with a notch.

12. The sound emitting device according to claim 1, wherein:
the vibration system further comprises a centring disk;
the centring disk comprises an outer fixing portion, an inner fixing portion, and a vibrating arm connecting the outer fixing portion and the inner fixing portion;
the outer fixing portion is connected to the housing;
the second diaphragm assembly comprises a folded ring portion and a second vibrating plate connected to the folded ring portion;
an outer peripheral edge of the folded ring portion is connected to the housing;
an inner edge of the second vibrating plate is connected to at least one of the first diaphragm assembly and the inner edge of the diaphragm; and
the inner fixing portion is connected to the second vibrating plate and the voice coil, and the inner fixing portion is electrically connected to a lead wire of the voice coil.

13. The sound emitting device according to claim 12, wherein:
the inner fixing portion comprises a body portion and a third extending portion extending from the body portion toward the voice coil; the body portion is connected to the second vibrating plate; the third extending portion is connected to the voice coil; the third extending portion or the body portion is provided with an inner soldering pad electrically connected to the lead wire of the voice coil; and/or
the outer fixing portion is annular, the outer fixing portion has short axis sides and long axis sides connected to each other in an alternating sequence, the vibrating arm leads out from a side of the inner fixing portion corresponding to the short axis side, bends, and then extends along the long axis side, and the vibrating arm is connected to a central region of the long axis side; and/or
the centring disk further comprises a conductive portion, a first end of the conductive portion is connected to the outer fixing portion, a second end of the conductive portion extends in a direction away from the housing, and the conductive portion is provided with an external soldering pad.

14. The sound emitting device according to claim 1, wherein:
the magnetic circuit system comprises a magnetic yoke, a central magnetic portion provided at the magnetic yoke and a side magnetic portion provided at the magnetic yoke;
the side magnetic portion is provided at an outer side of the central magnetic portion, and forms the magnetic gap together with the central magnetic portion;
the central magnetic portion comprises a first central magnet, a central pole plate, and a second central magnet;
the first central magnet, the central pole plate, and the second central magnet are provided in a stack;
the first central magnet is connected to the magnetic yoke;
an inner side of the inner folded ring is connected to the second central magnet; and
the first central magnet and the second central magnet are both magnetized along a vibration direction of the vibration system, and magnetization directions of the first central magnet and the second central magnet are opposite.

15. The sound emitting device according to claim 14, wherein:
the vibration system further comprises a centring disk, the centring disk comprises an outer fixing portion, an inner fixing portion, and a vibrating arm connecting the outer fixing portion and the inner fixing portion, the outer fixing portion is connected to the housing, and the inner fixing portion is connected to the voice coil and is electrically connected to a lead wire of the voice coil; and
the magnetic yoke is provided with a clearance structure corresponding to the inner fixing portion, and the clearance structure is a recessed groove or a through hole; and/or, the side magnetic portion comprises a plurality of side magnetic portions, a clearance space is formed between two adjacent side magnetic portions, the voice coil has a first protruding portion extending to the clearance space, and the first protruding portion is connected to the inner fixing portion; and/or
the side magnetic portion comprises a side magnet and a side pole plate, and the side magnet and the side pole plate are provided in a stack; the side magnet is connected to the magnetic yoke; the side pole plate is opposite to the central pole plate; and a magnetization direction of the side magnet is opposite to the magnetization direction of the first central magnet.

16. The sound emitting device according to claim 1, wherein:
the housing comprises a first housing and a second housing;
the first housing is provided with the sound output hole;
the outer peripheral edge of the outer folded ring and the outer peripheral edge of the diaphragm are both connected to the first housing;
the magnetic circuit system is connected to the second housing; and
the outer peripheral edge of the second diaphragm assembly is sandwiched between the first housing and the second housing.

17. The sound emitting device according to claim 16, wherein:
the first housing has a side wall and an inner bent portion formed by bending and extending inward from an end of the side wall away from the second housing;
the outer peripheral edge of the outer folded ring and the outer peripheral edge of the diaphragm are both connected to the inner bent portion;
the outer peripheral edge of the second diaphragm assembly is sandwiched between an end of the side wall away from the inner bent portion and the second housing; and
the sound output hole is provided at the side wall or the inner bent portion.

18. The sound emitting device according to claim 17, wherein:
the inner bent portion comprises an upper surface, a lower surface, and an inner side surface;
the upper surface and the lower surface face away from each other;
the inner side surface connects the upper surface and the lower surface, and is provided at an end of the inner bent portion away from the side wall; and
the outer peripheral edge of the outer folded ring is connected to the upper surface, and the outer peripheral edge of the diaphragm is connected to the lower surface; or, the outer peripheral edge of the outer folded ring is connected to the upper surface, and the outer peripheral edge of the diaphragm is sandwiched between the outer peripheral edge of the outer folded ring and the upper surface.

19. The sound emitting device according to claim 16, wherein the first housing is a metal housing, and the second housing is a metal housing;
the first housing is provided with a welding portion extending toward the magnetic circuit system; the welding portion is welded to the magnetic circuit system or the second housing; and/or, the magnetic circuit system or the second housing is provided with a welding portion extending toward the first housing; the welding portion is welded to an outer wall of the first housing; and/or, the sound emitting device further comprises a metal soldering piece; a first end of the metal soldering piece is welded to the magnetic circuit system or the second housing; a second end of the metal soldering piece is welded to the outer wall of the first housing; and/or
the second housing and the magnetic yoke of the magnetic circuit system are an integrally formed structure; and/or
the vibration system further comprises a centring disk; the centring disk comprises an outer fixing portion, an inner fixing portion, and a vibrating arm connecting the outer fixing portion and the inner fixing portion; the outer fixing portion is sandwiched between the second housing and the outer peripheral edge of the second diaphragm assembly; and the inner fixing portion is connected to the voice coil and is electrically connected to a lead wire of the voice coil.

20. A sound emitting module, comprising:
a module housing provided with a mounting cavity and a sound output port communicating with the mounting cavity; and
the sound emitting device according to claim 1;
wherein the sound emitting device is provided at the mounting cavity, a front acoustic cavity is formed between the first diaphragm assembly of the sound emitting device and the module housing, and the front acoustic cavity is communicated with the sound output port; and
the acoustic cavity of the sound emitting device is in communication with the sound output port through the front acoustic cavity; or, the module housing is further provided with a sound output channel, and the acoustic cavity of the sound emitting device is in communication with the sound output port through the sound output channel; or, the sound output hole of the sound emitting device faces and is in communication with the sound output port.
